(19) United States
(12) Patent Application Publication
(10) Pub. No.: US 2023/0054572 A1
(43) Pub. Date: Feb. 23, 2023

(54) AUTOMATED CAMERA TUNING

(71) Applicant: QUALCOMM Incorporated, San Diego, CA (US)

(72) Inventors: Aarrushi SHANDILYA, Delhi (IN); Naveen SRINIVASAMURTHY, Bangalore (IN); Shilpi SAHU, Bangalore (IN); Pawan Kumar BAHETI, Bangalore (IN); Adithya SESHASAYEE, Bengaluru (IN); Kapil AHUJA, Bengaluru (IN)

(21) Appl. No.: 17/796,871

(22) PCT Filed: Feb. 11, 2021
(86) PCT No.: PCT/US21/17713

§ 371 Date: Aug. 1, 2022

(30) Foreign Application Priority Data
Mar. 30, 2020 (IN) 202041013885

(51) Int. Cl. H04N 5/232

(52) U.S. Cl. CPC H04N 5/23222; H04N 5/23216

(57) ABSTRACT

Techniques and systems are provided for determining one or more camera settings. For example, an indication of a selection of an image quality metric for adjustment can be received, and a target image quality metric value for the selected image quality metric can be determined. A data point can be determined from a plurality of data points. The data point corresponds to a camera setting having an image quality metric value closest to the target image quality metric value.

### CROSS-REFERENCE TO RELATED APPLICATIONS

This application claims priority to Indian Application No. 202041013885 filed provisionally in India on Mar. 30, 2020, and entitled “AUTOMATED CAMERA TUNING”, which is hereby incorporated by reference, in their entirety and for all purposes.

### FIELD

The present disclosure generally relates to camera tuning, and more specifically to techniques and systems for performing automated camera tuning based on user feedback.

### BACKGROUND

An image capture device, such as a camera, can receive light and capture image frames, such as still images or video frames, using an image sensor. An image capture device can include processors (e.g., one or more image signal processors (ISPs)), that can receive and process one or more image frames. For example, a raw image frame captured by an image sensor can be processed by an ISP to generate a final image.

An ISP can process a captured image frame by applying a plurality of modules to the captured image frame. Each module may include a large number of tunable parameters (such as hundreds or thousands of parameters per module). Additionally, modules may be co-dependent as different modules may affect similar aspects of an image. For example, denoising and texture correction or enhancement may both affect high frequency aspects of an image. As a result, a large number of parameters are determined or adjusted for an ISP to generate a final image from a captured raw image.

### SUMMARY

Systems and techniques are described herein for performing automated camera tuning for determining one or more camera settings based on user feedback. According to one illustrative example, a method of determining one or more camera settings is provided. The method includes: receiving an indication of a selection of an image quality metric for adjustment; determining a target image quality metric value for the selected image quality metric; and determining, from a plurality of data points, a data point corresponding to a camera setting having an image quality metric value closest to the target image quality metric value.

In another example, an apparatus for determining one or more camera settings is provided that includes a memory configured to store at least one image and one or more processors implemented in circuitry and coupled to the memory. The one or more processors are configured to and can: receive an indication of a selection of an image quality metric for adjustment; determine a target image quality metric value for the selected image quality metric; and determine, from a plurality of data points, a data point corresponding to a camera setting having an image quality metric value closest to the target image quality metric value.

In another example, a non-transitory computer-readable medium is provided that has stored thereon instructions that, when executed by one or more processors, cause the one or more processor to: receive an indication of a selection of an image quality metric for adjustment; determine a target image quality metric value for the selected image quality metric; and determine, from a plurality of data points, a data point corresponding to a camera setting having an image quality metric value closest to the target image quality metric value.

In another example, an apparatus for determining one or more camera settings is provided. The apparatus includes: means for receiving an indication of a selection of an image quality metric for adjustment; means for determining a target image quality metric value for the selected image quality metric; and means for determining, from a plurality of data points, a data point corresponding to a camera setting having an image quality metric value closest to the target image quality metric value.

In some aspects, the indication of the selection of the image quality metric includes a direction of adjustment. In some aspects, the direction of adjustment includes a decrease in the image quality metric or an increase in the image quality metric.

In some aspects, the method, apparatuses, and computer-readable medium described above further comprise removing, from the plurality of data points, one or more data points having a same metric value for the selected image quality metric.

In some aspects, the method, apparatuses, and computer-readable medium described above further comprise receiving an indication of a selection of a particular camera setting for adjustment, wherein the selected image quality metric is associated with the selected particular camera setting.

In some aspects, the method, apparatuses, and computer-readable medium described above further comprise removing, from the plurality of data points, one or more data points corresponding to one or more camera settings having lower scores than the selected particular camera setting.

In some aspects, the method, apparatuses, and computer-readable medium described above further comprise removing, from the plurality of data points, one or more data points corresponding to one or more camera settings having a same metric value for the selected image quality metric and having lower scores than the selected particular camera setting.

In some aspects, the method, apparatuses, and computer-readable medium described above further comprise: determining, based on the indication of the selection of the image quality metric, a direction of adjustment for the image quality metric includes a decrease in the image quality metric; and removing, from the plurality of data points, one or more data points corresponding to one or more camera settings having a higher metric value for the selected image quality metric than the selected particular camera setting.

In some aspects, removing the one or more data points from the plurality of data points results in a group of data points. In some aspects, the method, apparatuses, and computer-readable medium described above further comprise sorting the group of data points in descending order.

In some aspects, the method, apparatuses, and computer-readable medium described above further comprise: determining, based on the indication of the selection of the image quality metric, a direction of adjustment for the image quality metric includes an increase in the image quality metric; and removing, from the plurality of data points, one or more data points corresponding to one or more camera settings having a lower metric value for the selected image quality metric than the selected particular camera setting.

In some aspects, removing the one or more data points from the plurality of data points results in a group of data points. In some aspects, the method, apparatuses, and computer-readable medium described above further comprise sorting the group of data points in ascending order.

In some aspects, the method, apparatuses, and computer-readable medium described above further comprise: determining a metric factor based on a metric value of the selected image quality metric, a data point from the plurality of data points having an extreme value for the selected image quality metric, and a number of the plurality of data points; and determining the target image quality metric value for the selected image quality metric based on the metric value of the selected image quality metric and the metric factor.

In some aspects, the method, apparatuses, and computer-readable medium described above further comprise: receiving an indication of a selection of a strength of the adjustment to image quality metric; and determining the target image quality metric value for the selected image quality metric based on the metric value of the selected image quality metric, the metric factor, and the strength of the adjustment to the image quality metric.

In some aspects, the method, apparatuses, and computer-readable medium described above further comprise: receiving an indication of a selection of a number of desired output camera settings; and determining the target image quality metric value for the selected image quality metric based on the metric value of the selected image quality metric, the metric factor, and the number of desired output camera settings.

In some aspects, the method, apparatuses, and computer-readable medium described above further comprise: receiving an indication of a selection of a strength of the adjustment to image quality metric; receiving an indication of a selection of a number of desired output camera settings; and determining the target image quality metric value for the selected image quality metric based on the metric value of the selected image quality metric, the metric factor, the strength of the adjustment to the image quality metric, and the number of desired output camera settings.

In some aspects, the method, apparatuses, and computer-readable medium described above further comprise outputting information associated with the determined data point for display.

In some aspects, the method, apparatuses, and computer-readable medium described above further comprise tuning an image signal process using the camera setting corresponding to the determined data point.

In some aspects, the selection of the image quality metric for adjustment is based on selection of a graphical element of a graphical user interface. In some aspects, the graphical element includes an option to increase or decrease the image quality metric. In some aspects, the graphical element is associated with a displayed image having an adjusted value for the image quality metric.

In some aspects, the selection of the image quality metric for adjustment is based on selection of a displayed image frame having an adjusted value for the image quality metric.

In some aspects, the apparatus comprises a camera, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, the apparatus includes a camera or multiple cameras for capturing one or more image frames. In some aspects, the apparatus further includes a display for displaying one or more image frames, notifications, and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a diagram illustrating an architecture of a camera system, in accordance with some examples;

FIG. 2 is a diagram illustrating an example of a manual tuning process for tuning image signal processor (ISP) parameters, in accordance with some examples;

FIG. 3A and FIG. 3B are examples of image frames illustrating an expected image quality (IQ) change resulting from fine tuning, in accordance with some examples;

FIG. 4A and FIG. 4B are examples of image frames illustrating an expected IQ change resulting from fine tuning, in accordance with some examples;

FIG. 5A and FIG. 5B are examples of image frames illustrating a desired IQ change resulting from fine tuning, in accordance with some examples;

FIG. 6 is a diagram illustrating an example of a graphical user interface of an automated camera tuning tool, in accordance with some examples;

FIG. 7 is a flow diagram illustrating an example of a process for performing automated camera tuning, in accordance with some examples;

FIG. 8 is a flow diagram illustrating an example of a parameter settings search process, in accordance with some examples;

FIG. 9A and FIG. 9B are image frames illustrating a comparison between capture results obtained using course-tuned settings and capture results obtained using fine-tuned settings determined using the techniques described herein, in accordance with some examples;

FIG. 10A and FIG. 10B are image frames illustrating a comparison between capture results obtained using course-tuned settings and capture results obtained using fine-tuned settings determined using the techniques described herein, in accordance with some examples;

FIG. 11A and FIG. 11B are image frames illustrating a comparison between capture results obtained using course-tuned settings and capture results obtained using fine-tuned settings determined using the techniques described herein, in accordance with some examples;

FIG. 12 is a flow diagram illustrating an example of a process for performing automated camera tuning using the techniques described herein, in accordance with some examples;

FIG. 13 is a diagram illustrating an example of a graphical user interface of an automated camera tuning tool, in accordance with some examples;

FIG. 14A and FIG. 14B are image frames illustrating a comparison between capture results obtained using originally-tuned settings of a device and capture results obtained using fine-tuned settings for the device determined using the techniques described herein, in accordance with some examples;

FIG. 15 is a flow diagram illustrating an example of a process of determining one or more camera settings using the techniques described herein, in accordance with some examples; and

FIG. 16 is a block diagram of an example computing device that may be used to implement some aspects of the technology described herein, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera (also referred to as an image capture device) is a device that receives light and captures image frames, such as still images or video frames, using an image sensor (also referred to as a camera sensor). Cameras may include processors, such as image signal processors (ISPs), that can receive one or more image frames and process the one or more image frames. For example, a raw image frame captured by an image sensor can be processed by an ISP to generate a final image. The ISP can process a captured image frame by applying a plurality of modules or processing blocks (e.g., filters) to the captured image frame. The modules can include processing blocks for denoising or noise filtering, edge enhancement (e.g., using sharpening filters), color balancing, contrast, intensity adjustment (such as darkening or lightening), tone adjustment, lens/sensor noise correction, Bayer filtering (using Bayer filters), demosaicing, color conversion, correction or enhancement/suppression of image attributes, among others. Each module may include a large number of tunable parameters (such as hundreds or thousands of parameters per module). Additionally, modules may be co-dependent as different modules may affect similar aspects of an image. For example, denoising and texture correction or enhancement may both affect high frequency aspects of an image. A large number of parameters are thus determined or adjusted for an ISP to generate a final image from a captured raw image.

The parameters for an ISP are conventionally tuned manually by an expert with experience in how to process input images for desirable output images. Camera tuning can be a time consuming and resource intensive process. For example, as a result of the correlations between ISP modules (e.g., filters) and the sheer number of tunable parameters, an expert may require several weeks (e.g., 3-8 weeks) to determine, test, and/or adjust device settings for the parameters based on a combination of a specific image/camera sensor and ISP. Because the camera sensor or other camera features (e.g., lens characteristics or imperfections, aperture size, shutter speed and movement, flash brightness and color, and/or other features) can impact the captured image and therefore at least some of the tunable parameters for the ISP, each image/camera sensor and ISP combination would need to be tuned by an expert.

Systems, apparatuses, methods (also referred to as processes), and computer-readable media (collectively referred to herein as “systems and techniques”) are described herein that provide automated camera tuning. As described in more detail herein, the automated camera tuning systems and techniques can be used to automatically tune an ISP, an image/camera sensor, and/or other component of a camera system. In some examples, an automated camera tuning tool can be used to implement or perform the automated camera tuning techniques described herein. The automated camera tuning tool can be used to perform fine tuning of an ISP by interacting with a graphical user interactive (GUI) of the automated camera tuning tool. Further details regarding the systems and techniques are provided herein with respect to various figures.

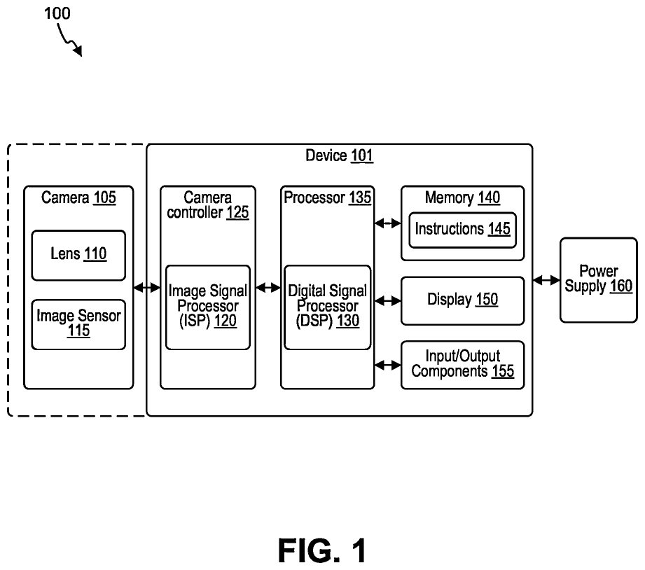

FIG. 1 is a diagram illustrating an architecture of a camera system 100 including a device 101. The device 101 of FIG. 1 includes various components, including a camera controller 125 with an image signal processor (ISP) 120, a processor 135 with a digital signal processor (DSP) 130, a memory 140 storing instructions 145, a display 150, and input/output (I/O) components 155. The device 101 may be connected to a power supply 160.

The camera system 100 also includes a camera 105. The camera controller 125 may receive image data from the camera 105. In some cases, an image sensor 115 (also referred to as a camera sensor) of the camera 105 can send the image data to the camera controller 125. As shown in FIG. 1, the camera 105 includes a lens 110. The lens 110 can receive light from a scene including a subject. The lens 110 directs the light to the image sensor 115, which includes a pixel array used to generate image frames (also referred to as images or frames). The image sensor 115 outputs image frames to the device 101 (e.g., to one or more processors of the device 101) in response to the image sensor 115 receiving light for each of the image frames. The device 101 receives the image frames from the image sensor 115 and processes the image frames via one or more processors. The camera 105 may either be a part of the device 101, or may be separate from the device 101. In some implementations, the camera 105 can include the camera controller 125.

The device 101 of FIG. 1 may include one or more processors. The one or more processors of the device 101 may include the camera controller 125, the image signal processor (ISP) 120, the processor 135, the digital signal processor (DSP) 130, or a combination thereof. The ISP 120 and/or the DSP 130 may process the image frames from the image sensor 115. In some examples, the DSP 130 can be a host processor (HP) (also referred to as an application processor (AP) in some cases). The DSP 130 (as an HP) can be used to dynamically configure the image sensor 115 with new parameter settings. The DSP 130 (as an HP) can also be used to dynamically configure parameter settings of the ISP 120 (e.g., to match the settings of an image frame from the image sensor 115 so that the image data is processed correctly).

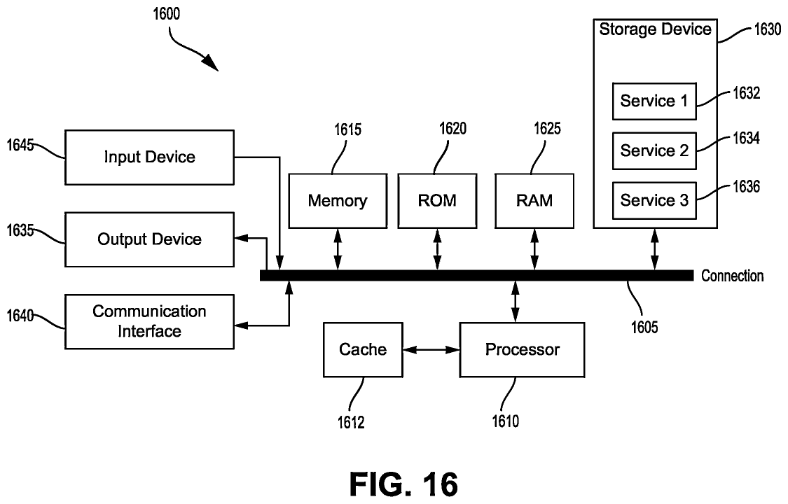

The ISP 120 and/or the DSP 130 can generate visual media that may be encoded using an image and/or video encoder. The visual media may include one or more processed still images and/or one or more videos that include video frames based on the image frames from the image sensor 115. The device 101 may store the visual media as one or more files on the memory 140. The memory 140 may include one or more non-transitory computer-readable storage medium components, each of which may be any type of memory or non-transitory computer-readable storage medium discussed with respect to the memory 1615 of FIG. 16. In some cases, one or more of the one or more non-transitory computer-readable storage medium components of the memory 140 and may optionally be removable. Illustrative examples of memory 140 may include a secure digital (SD) card, a micro SD card, a flash memory component, a hard drive, random access memory (RAM) such as dynamic RAM (DRAM) or static RAM (SRAM), another storage medium, or some combination thereof.

The display 150 can be any suitable display or screen allowing for user interaction and/or to present items (such as captured image frames, video, or a preview image) for viewing by a user. In some aspects, the display 150 can be a touch-sensitive display. The I/O components 155 may be or include any suitable mechanism, interface, or device to receive input (such as commands) from the user and to provide output to the user. For example, the I/O components 155 may include (but are not limited to) a graphical user interface, keyboard, mouse, microphone and speakers, and so on. The display 150 and/or the I/O components 155 may provide a preview image to a user and/or receive a user input for adjusting one or more settings of the camera 105 and/or the ISP 120 (such as selecting and/or deselecting a region of interest of a displayed preview image for an autofocus (AF) operation).

The ISP 120 can process captured image frames or video provided by the image sensor 115 of the camera 105. The ISP 120 can include a single ISP or can include multiple ISPs. Examples of tasks that can be performed by different modules or processing blocks of the ISP 120 can include demosaicing (e.g., interpolation), autofocus (and other automated functions), noise reduction (also referred to as denoising or noise filtering), lens/sensor noise correction, edge enhancement (e.g., using sharpening filters), color balancing, contrast, intensity adjustment (such as darkening or lightening), tone adjustment, Bayer filtering (using Bayer filters), color conversion, correction or enhancement/suppression of image attributes, and/or other tasks. In some examples, the camera controller 125 (e.g., the ISP 120) may also control operation of the camera 105. In some cases, the ISP 120 can process received image frames using parameters provided from a parameter database (not shown) stored in memory 140. The processor 135 can determine the parameters from the parameter database to be used by the ISP 120. The ISP 120 can execute instructions from a memory (e.g., memory 140) to process image frames or video, may include specific hardware to process image frames or video, or additionally or alternatively may include a combination of specific hardware and the ability to execute software instructions for processing image frames or video.

In some examples, image frames may be received by the device 101 from sources other than a camera, such as other devices, equipment, network attached storage and/or other storage, among other sources. In some cases, the device 101 can be a testing device where the ISP 120 is removable so that another ISP may be coupled to the device 101 (such as a test device, testing equipment, and so on).

The components of the device 101 can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

While the device 101 is shown to include certain components, one of ordinary skill will appreciate that the device 101 can include more or fewer components than those shown in FIG. 1. For example, the device 101 can also include one or more input devices and one or more output devices (not shown). In some implementations, the device 101 may also include, or can be part of a computing device that includes, one or more memory devices other than the memory 140 (e.g., one or more random access memory (RAM) components, read-only memory (ROM) components, cache memory components, buffer components, database components, and/or other memory devices), one or more processing devices other than the processor 135 and/or DSP 130 (e.g., one or more CPUs, GPUs, and/or other processing devices) in communication with and/or electrically connected to the one or more memory devices, one or more wireless interfaces (e.g., including one or more transceivers and a baseband processor for each wireless interface) for performing wireless communications, one or more wired interfaces (e.g., a serial interface such as a universal serial bus (USB) input, a lightening connector, and/or other wired interface) for performing communications over one or more hardwired connections, and/or other components that are not shown in FIG. 1.

In some implementations, the device 101 can include a camera device, a mobile device, a personal computer, a tablet computer, a wearable device, an extended reality (XR) device (e.g., a virtual reality (VR) device, an augmented reality (AR) device, and/or a mixed reality (MR) device), a server (e.g., in a software as a service (SaaS) system or other server-based system), and/or any other computing device with the resource capabilities to perform the techniques described herein.

In some cases, the device 101 can include one or more software applications, such as a camera tuning application that incorporates the techniques described herein. The software application can be a mobile application, a desktop application, or other software application installed on the device 101.

As described above, a camera system or component of the camera system (e.g., the ISP 120, the image sensor 115, and/or other components) can be tuned so that the camera system provides a desired image quality. For example, parameters of the ISP 120 can be adjusted in order to optimize performance of the ISP 120 when processing an image frame captured by the image sensor 115. In some cases, an image quality system and/or software can analyze image frames (e.g., digital images and/or video frames) output by a camera system (e.g., the camera system 100). For instance, the image quality system and/or software can analyze image frames using one or more test charts, such as the TE42 chart among others. The image quality system and/or software can output various image quality (IQ) metrics relating to characteristics of the camera system. IQ metrics can include metrics such as Opto-Electric Conversion Function (OECF), dynamic range, white balancing, noise and ISO-Speed, visual noise, Modulation Transfer Function (MTF), limiting resolution, distortion, lateral and/or longitudinal chromatic aberration, vignetting, shading, flare, color reproduction, any combination thereof, and/or other characteristics.

The characteristics of a camera system can be used to perform various functions for tuning a camera system. For example, image quality issues can be debugged and ISP parameters can be fine-tuned based on specific user IQ requirements. In some cases, a user can include an original equipment manufacturer (OEM). Different OEMs can request different quality requirements for different devices. For instance, based on the quality requirements of a particular OEM and the characteristics provided by an image quality system and/or software, ISP parameters can be adjusted so that performance of the ISP is optimized when processing an image frame using a certain task. As noted above, tasks of an ISP can include demosaicing (e.g., interpolation), autofocus (and other automated functions), noise reduction, lens corrections, among other tasks.

As noted above, camera tuning can be a time consuming and resource intensive process. For example, tuning the parameters of an ISP of a camera system can require a rigorous manual process, which in some cases can take weeks to complete. An initial part of the camera tuning process can include coarse tuning of the parameters of an ISP. Course tuning the parameters of an ISP can include tuning the parameters to target a benchmark IQ. In one illustrative example, if a camera system of a particular OEM's device (e.g., a mobile phone) has the best IQ on the market, that IQ can be used as the benchmark IQ. When tuning other devices coming to market, tuning engineers can target the benchmark IQ as closely as possible in the initial round of tuning for the other devices. One example of a benchmark for IQ assessment is DXOMark (https://www.dxomark.com), for example based on the DXOMark Analyzer.

With the number of tunable parameters for an ISP possibly reaching hundreds or thousands, a reduced number of IQ metrics may be mapped to the tunable parameters of the ISP. Mapping the reduced number of IQ metrics to the tunable parameters can allow a person tuning the ISP to focus on the reduced number of IQ metrics rather than the larger number of tunable parameters. IQ metrics are measurements of perceivable attributes of an image (with each perceivable attribute called a “ness”). Example attributes or nesses include the luminance of an image frame, the sharpness of an image frame, the graininess of an image frame, the tone of an image frame, the color saturation of an image frame, and so on. Such attributes or nesses are perceived by a person if changed for a particular image frame. For example, if a luminance of an image frame is decreased, a person perceives the image frame to be darker.

In some examples, the number of IQ metrics may be 10-20 (or other number), with each IQ metric corresponding to a plurality of tunable parameters. In some cases, two or more different IQ metrics may affect some of the same tunable parameters for the ISP. In some examples, a parameter database may correlate different values of IQ metrics to different values for the parameters. For example, an input vector of IQ metrics may be associated with an output vector of tunable parameters so that an ISP may be tuned for the corresponding IQ metrics. Because the number of parameters may be large, the parameter database may not store all combinations of IQ metrics, but instead may include a portion of the number of combinations. While the device 101 of FIG. 1 was described as including the parameter database in the memory 140, the database may be stored outside of the device 101 (such as in a network attached storage, cloud storage, testing equipment coupled to device 101, and so on). In some cases, the parameters may impact components outside of the ISP (such as the camera 105 shown in FIG. 1). The present disclosure should not be limited to specific described parameters or parameters specific only to the ISP. For example, the parameters may be for a specific ISP and camera (or image/camera sensor) combination, or for different ISP and camera (or image/camera sensor) combinations.

In some examples, an IQ model may be used to map the IQ metrics to the tunable parameters. Any type of IQ model may be used, and the present disclosure is not limited to a specific IQ model for correlating IQ metrics to ISP parameters. In some examples, the IQ model can include one or more modulation transfer functions (MTFs) to determine changes in the ISP parameters associated with a change in an IQ metric. For example, changing a luminance IQ metric may correspond to parameters associated with adjusting an image/camera sensor sensitivity, shutter speed, flash, the ISP determining an intensity for each pixel of an incoming image, the ISP adjusting the tone or color balance of each pixel for compensation, and/or other parameters. A luminance MTF may be used to indicate that a change in the luminance IQ metric corresponds to specific changes in the correlating parameters.

The IQ model and/or MTFs can vary between different ISPs or can vary between different combinations of ISPs and cameras (or camera/image sensors). Tuning the ISP can include determining the differences in MTFs or the IQ model so that the IQ metric values are correlated to preferred tunable parameter values for the ISP (in the parameter database). An “optimally” processed image frame may be based on user preference or may be subjective for one or more experts, resulting in the optimization of an IQ model being open ended and subject to differences between users or persons assisting with the tuning. However, an IQ can be quantified, such as by using an IQ scale (such as from 0 to 100, with 100 being the best) to indicate the IQ performance for an ISP and/or a camera. For example, the IQ for a processed image frame can be quantified, and an expert can use the quantification to tune an ISP (such as adjusting or determining the parameters for the ISP or the combination of the ISP and camera sensor).

Some IQ metrics may be opposed to one another, such as noisiness (corresponding to an amount of noise) and texture, where reducing or increasing the noise may correspondingly reduce or increase the high frequency texture information in an image. When tuning an ISP, trade-offs are determined between IQ metrics in an attempt to optimize processing of an image (such as by generating the highest quantified IQ score from an IQ scale).

Optimizing the IQ metrics or otherwise tuning an ISP may differ for different scene types. For example, indoor scenes illuminated by incandescent lighting may correspond to different “optimal” IQ metrics (and corresponding parameters) than outdoor scenes with bright natural lighting. In another example, a scene with large flat fields of color and luminance may correspond to different “optimal” IQ metrics than a scene with large numbers of colors and variances in color within a field. As a result, an ISP may be tuned for a plurality of different scene types.

A goal of camera tuning is to achieve better IQ than previously-existing products that are on the market. Such an increase in IQ can become even more prominent as image/camera sensors and ISPs continue to evolve. As noted above, course tuning of the ISP parameters can target a benchmark IQ. In some cases, it can be difficult to achieve the same IQ as the benchmark IQ. For instance, different devices (e.g., different mobile device camera systems) can have different image/camera sensor and ISP combinations and/or configurations. Such differences can make it difficult and in some cases impossible to achieve the same type of trade-off for a device as that of the device that set the benchmark IQ. After the initial course tuning, fine tuning (e.g., user preferential tuning) can be performed. For example, a user (e.g., an OEM) can provide specific feedback (e.g., requirements) that can be implemented by a tuning engineer when fine tuning the image/camera sensor and/or ISP of a particular device. Examples of feedback can include a desire for more noise cleaning (e.g., denoising) at one or more lower lux conditions (e.g., low light, normal light, bright light, and/or other lux conditions), better saturation levels in bright light, and/or other feedback.

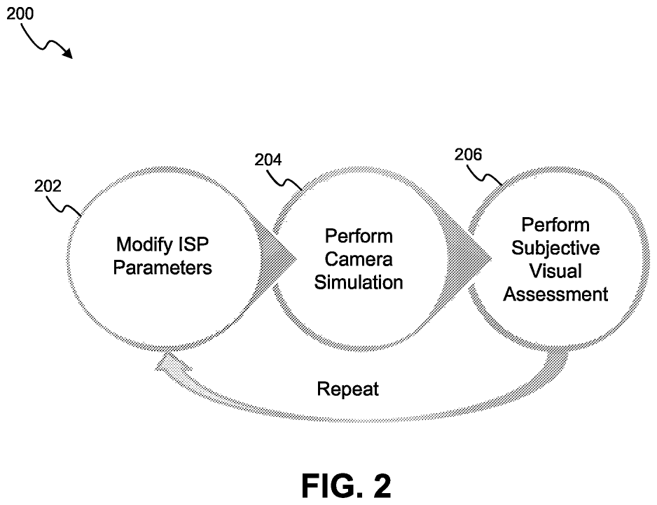

FIG. 2 is a diagram illustrating an example of a manual tuning process 200 for tuning ISP parameters. The manual tuning process 200 is performed to determine how ISP parameter changes reflect the image quality. At operation 202, the process 200 includes modifying ISP parameters (e.g., based on feedback received from operation 202 from a previous iteration). At operation 204, the process 200 includes performing camera simulation using the currently-tuned ISP parameters (e.g., as modified at operation 202). A result of operation 204 can be one or more output images and/or one or more output video frames.

At operation 206, the process 200 includes performing subjective visual assessment of the one or more output images and/or video frames, in order to determine if a desired change occurred in the output. The process 200 can be repeated by providing feedback based on the subject visual assessment performed at operation 206. In some cases, a designer and/or manufacturer of a camera system can perform operations 202, 204, and 206 based on requirements provided by a user (e.g., an OEM). In some cases, a designer and/or manufacturer of a camera system can perform operations 202 and 204, and a user (e.g., an OEM) can perform operation 206.

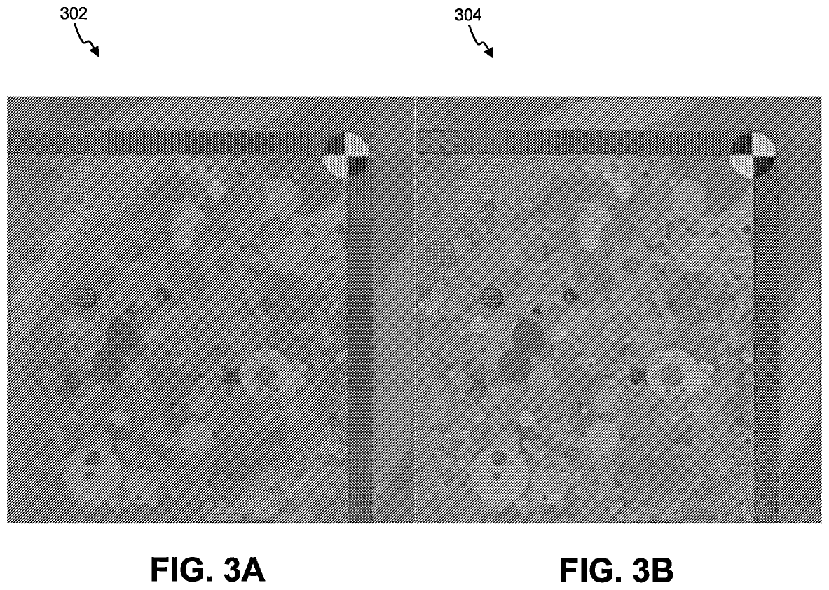

FIG. 3A and FIG. 3B are examples of image frames 302 and 304 captured by a camera of a mobile device with a sensor-ISP combination of an IMX363 sensor and a Snapdragon 845 ISP. The image frames 302 and 304 in FIG. 3A and FIG. 3B illustrate an expected IQ change resulting from fine tuning (from the tuner perspective). In particular, the image frames 302 and 304 in FIG. 3A and FIG. 3B provide a comparison between coarse-tuned settings and fine-tuned settings for texture and noise. The image frame 302 in FIG. 3A is generated by an ISP with course-tuned settings. The image frame 304 in FIG. 3B is generated by the ISP with fine-tuned settings. It can be observed from FIG. 3A and FIG. 3B that the fine-tuned settings provide an image frame (the image frame 304 in FIG. 3B) with improved texture details and cleaner noise profile as compared to the same image frame (the image frame 302 in FIG. 3A) generated using the course-tuned settings.

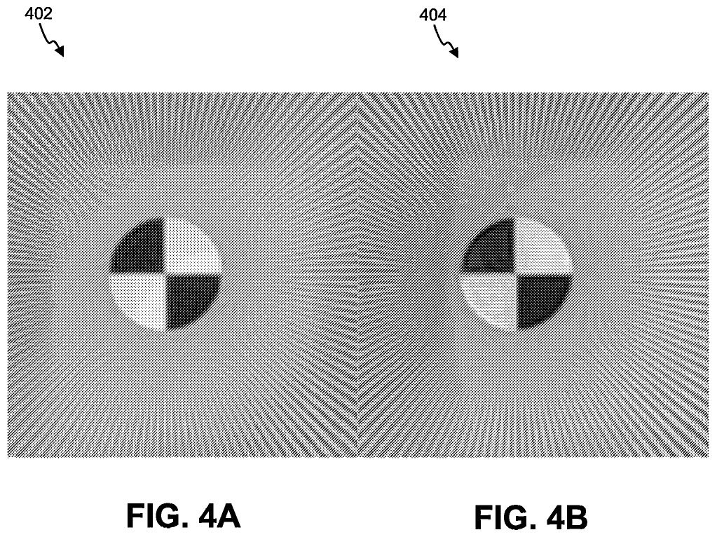

FIG. 4A and FIG. 4B are further examples of image frames 402 and 404 captured by a mobile device with a sensor-ISP combination of an IMX363 sensor and a Snapdragon 845 ISP. The image frames 402 and 404 in FIG. 4A and FIG. 4B illustrate an expected IQ change resulting from fine tuning (from the tuner perspective). In particular, the image frames 402 and 404 in FIG. 4A and FIG. 4B provide a comparison between the coarse-tuned settings and the fine-tuned settings for resolution. The image frame 402 in FIG. 4A is generated by an ISP with course-tuned settings, and the image frame 404 in FIG. 4B is generated by the ISP with fine-tuned settings. From FIG. 4A and FIG. 4B, it can be observed that the fine-tuned settings provide an image frame (the image frame 404 in FIG. 4B) with better high frequency resolution as compared to the same image frame (the image frame 402 in FIG. 4A) generated using the course-tuned settings.

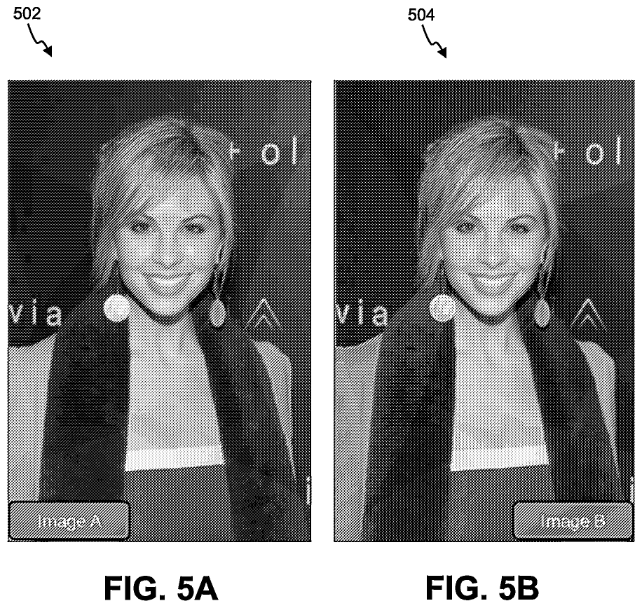

FIG. 5A and FIG. 5B are examples of image frames 502 and 504 captured by a camera. The image frames 502 and 504 illustrate a desired IQ change resulting from fine tuning (from the end-user perspective). The image frame 502 in FIG. 5A is generated based on the default ISP parameter settings chosen by one or more tuning engineers. However, the camera end-user may have a fixed preference of a hue shift by 6 degrees and increased saturation of 9% for skin tone, as shown by the image frame 504 in FIG. 5B, keeping rest of the quality aspects of the image frame 504 the same as the image frame 502 of FIG. 5A. Currently, camera end-users are not able to change ISP parameter settings for their desired change(s).

A manual iterative procedure (e.g., the process shown in FIG. 2) for evaluating how small ISP parameter changes are reflected in the Image Quality (IQ) of an image frame is tedious and inefficient for multiple ISP-sensor combinations. The process can become even more tedious and less efficient when performed across different operating conditions (e.g., tuning the same parameters for different lux conditions). In some cases, even after a tuning engineer finalizes the ISP parameters for an optimal IQ (e.g., with respect to an OEM's preferences), the image quality may not correspond to the ideal or desired IQ from the perspective of the camera end-user.

As noted above, existing camera tuning systems and techniques require tuning engineers to have expertise over many ISP parameters (e.g., thousands of ISP parameters). Such expertise is needed to manually tune ISP parameters for obtaining suitable IQ trade-offs (e.g., texture-noise trade-off) based on feedback from a user (e.g., an OEM). The iterative manual process described above (e.g., with respect to FIG. 2) is a time and resource intensive process, including simulation and visual assessment after every small change in parameter settings. For instance, manual tuning for eight different lux conditions can take 7-10 days, or even longer in some cases. Such a process is inefficient and has repeatability concerns. Tracking every small change in parameter settings from start to finish can also be cumbersome. Further, each time a new ISP module is added or modified, a tuning engineer needs to establish in-depth knowledge of the impact all the parameters of the new ISP module have on the IQ of output image frames.

As noted above, automated camera tuning systems and techniques are described herein that provide automated camera tuning. For example, the automated camera tuning systems and techniques can be used to automatically tune an ISP, a camera sensor (or image sensor), or other component of a camera system. In some examples, the automated camera tuning can be implemented using an automated camera tuning tool. For instance, any type of user (e.g., an OEM tuning engineer, a camera end-user, and/or other users) can perform fine tuning of an ISP by interacting with a graphical user interactive (GUI) of the automated camera tuning tool.

The GUI of the camera tuning tool can include selectable graphical elements. A user can interact with the selectable graphical elements to indicate the user's desired change in image quality (IQ). For instance, based on selection by a user of one or more of the selectable graphical elements, the camera tuning tool can perform real time (or near real time) selection of ISP parameter settings with respect to the user's desired change in IQ. In some cases, using the GUI of the camera tuning tool, the user can select a particular coarse-tuned setting and can direct the kind of IQ improvement that is desired or required relative to the course-tuned setting (e.g., an increase in texture, a decrease in noise, etc.). The automated camera tuning tool can generate new settings options that will have an overall IQ similar to the selected setting, with the desired aspect of IQ enhanced. In some cases, the camera tuning tool and/or the GUI of the camera tuning tool can be different for different types of users. For instance, a first GUI can be provided for OEM users and a second GUI (that is different from the first GUI) can be provided for camera end-users.

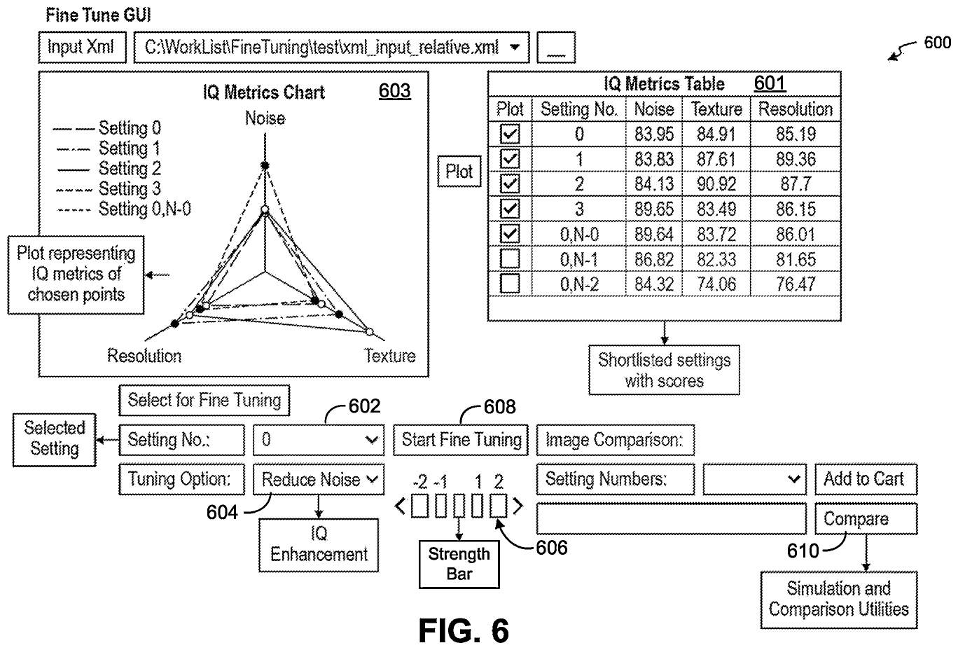

In some cases, the GUI of the automated camera tuning tool (e.g., the GUI shown in FIG. 6) can be used to obtain user feedback regarding a specific aspect of IQ (e.g., texture, noise, edge sharpness, ringing artifact, among others). The feedback can be translated or converted into a corresponding IQ metric target (e.g., by determining a target metric value using equation (2) below). In some cases, a parameter settings search can be performed to search from among pre-generated trade-off ISP settings to obtain the settings that provide an IQ metric closest to the IQ metric target. Trade-off ISP settings refer to a set of data points with varying IQ metrics (e.g., points with high texture-high noise and low texture-low noise). For example, while tuning, a user (e.g., an OEM) may modify parameters to obtain an optimal “trade-off” between noise and texture metrics. In some cases, a camera tuner can pre-generate multiple ISP settings, with each ISP setting having a different trade-off (e.g., texture-noise trade-off) from which a user (e.g., an OEM) can choose. Each ISP setting corresponds to one IQ metric trade-off.

For instance, as noted above and described in more detail below, a parameter settings search can be performed to identify a particular set of settings that meet an IQ metric target. Using the automated camera tuning tool, a user can select certain IQ metrics (also referred to as IQ features) that the user desires to adjust for given settings (e.g., ISP settings), and the parameter settings search can be performed to determine particular settings that correspond to the user's selections. In one illustrative example, for given settings of an ISP, a user can indicate a desire to reduce the noise resulting in an image frame produced using the given ISP settings. The parameter settings search can be performed to determine the best ISP settings that will provide the desired noise quality, but without reducing the quality of other IQ metrics (e.g., texture, resolution, etc.). In some cases, the user can indicate a strength of the IQ metric adjustment (e.g., decrease by a factor of −1, −2, −3, etc., or increase by a factor of 1, 2, 3, etc.).

FIG. 6 is a diagram illustrating an example of a graphical user interface (GUI) 600 of an automated camera tuning tool. An example of a user of the GUI 600 is an OEM user (e.g., a tuning engineer, a device engineer, software engineer, or other user) that can tune the ISP of a device the OEM is manufacturing. Another example of a user of the GUI 600 is an end-user (e.g., a consumer that purchases a camera that can be tuned using the automated camera tuning tool). As shown in FIG. 6, various settings are shown in an image quality (IQ) metrics table 601. Each setting is included in the IQ metrics table 601 with a given setting number, including setting numbers 0, 1, 2, 3, 0, N−0, 0, N−1, and 0, N−3. Each setting corresponds to tuned ISP parameters with which an ISP has been tuned. For instance, the settings in the IQ metrics table 601 can include course-tuned ISP metrics, which can be fine-tuned using the automated camera tuning tool based on input received via the GUI 600.

Values of various IQ metrics are shown in the IQ metrics table 601 for each ISP setting, including a noise metric, a texture metric, and a resolution metric. For example, for the ISP setting with setting number 0, the noise metric has a value of 83.95, the texture metric has a value of 84.91, and the resolution metric has a value of 85.19. The values provided for the IQ metrics can include any value (e.g., any score-based value) indicating a quality of the given metric. In some examples, the example values for the IQ metrics shown in FIG. 6 can be generated using a scoring mechanism that combines multiple IQ metrics to provide a score for a given characteristic. For instance, multiple IQ metrics can correspond to different aspects of sharpness, including an IQ metric for texture in a high contrast region, an IQ metric for texture in a low contrast region, and an IQ metric for resolution. The IQ metrics can be combined together to generate a sharpness score that represents the sharpness. In another example, the noise in the luminance domain and the noise in the color domain can be combined into a noise score. Such a score generated using multiple IQ metrics can be referred to as an IQ score. An IQ metrics chart 603 is also shown in FIG. 6. The IQ metrics chart 603 plots the different IQ metric values for different settings of the IQ metrics table 601.

The GUI 600 includes various selectable graphical elements that a user can interact with to operate the automated camera tuning tool. For example, a setting number graphical element 602 allows a user to select a particular setting number for fine tuning. A tuning option graphical element 604 allows a user to select the tuning option the user prefers to adjust for a setting selected using the setting number graphical element 602. As shown in FIG. 6, a user has selected “reduce noise” as a preferred adjustment to setting number 0. A strength bar 606 is provided as a selectable graphical element to allow a user to indicate the strength or intensity of the adjustment of the tuning option (e.g., noise) that will be applied to the selected setting (e.g., setting number 0). The strength bar 606 is optional, and may be omitted from the tuning tool GUI 600 in some implementations. The user can select the start fine tuning graphical element 608 to cause the automated camera tuning tool to begin the fine tuning process.

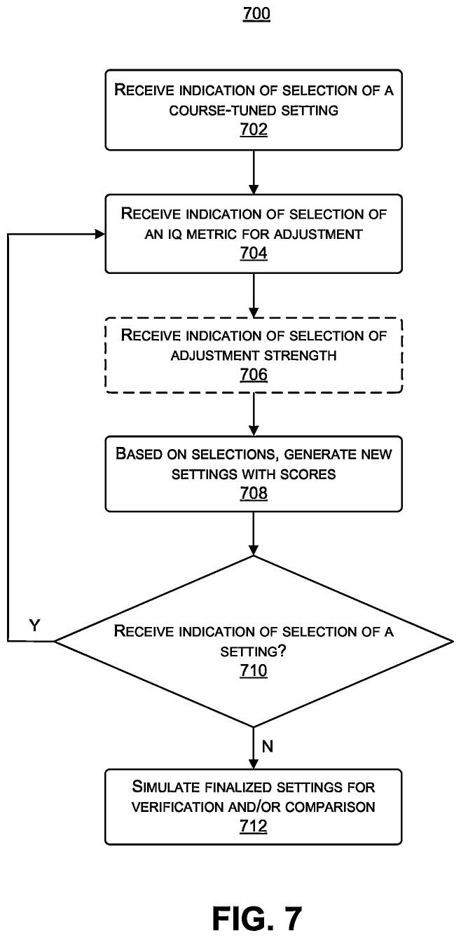

FIG. 7 is a flow diagram illustrating an example of a process 700 for performing automated camera tuning based on input received from a GUI (e.g., GUI 600 of FIG. 6) of the automated camera tuning tool. The process 700 can be used to fine tune camera settings (e.g., ISP settings) based on user preferences, as indicated through the use of the GUI of the automated camera tuning tool (e.g., the GUI 600).

At operation 702, the process 700 includes receiving an indication of selection of a course-tuned setting for an ISP or other camera component. For instance, the process 700 can receive an indication of a selection of a course-tuned setting in response to a user selecting a setting with a particular setting number from the IQ metrics table 601 of the GUI 600 shown in FIG. 6. The course-tuned setting can be based on tuning of an ISP (or other camera component) to reach a benchmark IQ. A user can select a setting based on a displayed IQ score (e.g., as shown in the IQ metrics table 601 of FIG. 6). As described herein, an IQ score can be determined for a particular IQ feature (e.g., sharpness, noise, artifacts, etc.) and correlates with subjective IQ. An IQ can be computed for each ISP setting and can be displayed for the user to help in choosing a setting for fine-tuning.

The user may desire that the course-tuned setting be fine-tuned based on one or more IQ metrics. The user can select one or more graphical element of the GUI in order to cause the automated camera tuning tool to adjust the one or more IQ metrics of the course-tuned setting. At operation 704, the process 700 includes receiving an indication of selection of an IQ metric for adjustment. For example, the process 700 can receive an indication of a selection of an IQ metric for adjustment in response to a user selecting (e.g., using the tuning option graphical element 604 in the GUI 600 of FIG. 6) an IQ metric to adjust for a particular setting. As noted above, the user can select the particular setting using the setting number graphical element 602. Various IQ metrics can be selected for adjustment, including noise, sharpness, texture, edge, overshoot, resolution, among others.

At operation 706, the process 700 includes receiving an indication of selection of adjustment strength. For example, the process 700 can receive an indication of a selection of adjustment strength in response to a user selecting (e.g., using the strength bar 606 in the GUI 600 of FIG. 6), a strength or intensity of the adjustment of the IQ metric. In one illustrative example, the user can indicate that the noise is to be reduced by a factor of −2.

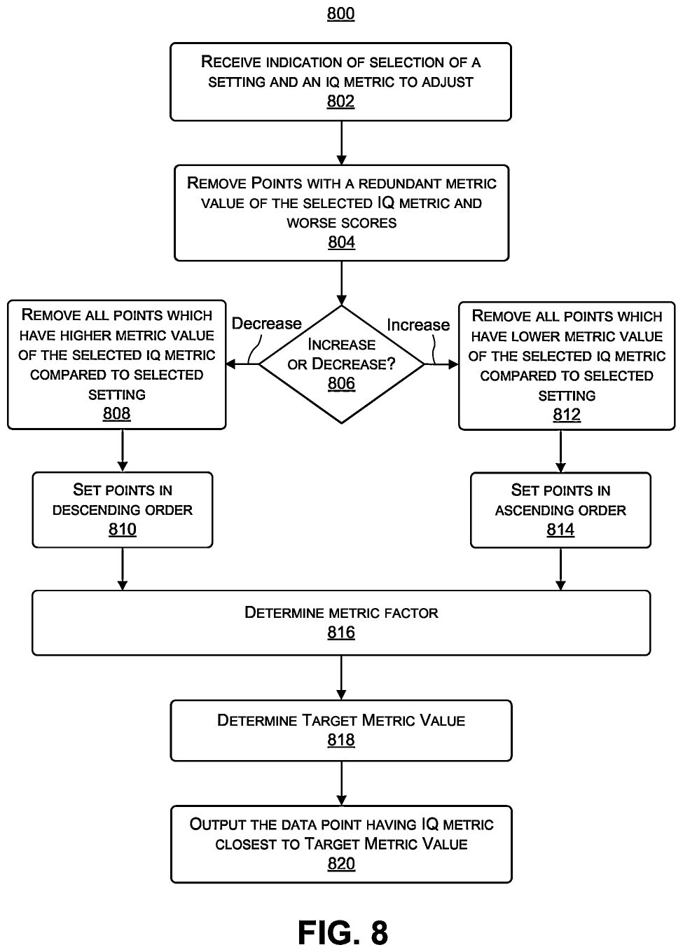

At operation 708, the process 700 includes generating new settings with updated IQ scores based on the selections from operations 702, 704, and 706. In one illustrative example, the new settings with the updated IQ scores can be displayed in the IQ metrics table 601 of the GUI 600 shown in FIG. 6. In some implementations, a parameter settings search process (described below with respect to FIG. 8) can be used to generate the new settings based on a user's selection of a setting, an IQ metric for adjustment, and optionally an adjustment strength.

At operation 710, the process 700 includes determining whether an indication of selection of an additional setting is received. As noted above, a user can select a setting based on a displayed IQ score (e.g., as shown in the IQ metrics table 601 of FIG. 6). The additional setting can include another course-tuned setting or a fine-tuned setting after a course-tuned setting is updated based on the user selecting that setting for adjustment. If selection of an additional setting is determined, the process 700 returns to operation 704 to receive an indication of selection of an IQ feature to adjust for the additional setting. In some cases, the process 700 can repeat until no further settings are selected.

In some cases, once no further additional settings are selected, the process 700 performs operation 712. At operation 712, the process 700 includes providing an option for simulating the finalized settings. Simulation of the finalized settings can be performed for verification and/or comparison by the user. For instance, the GUI for the automated camera tuning tool can provide a simulate option (e.g., the compare graphical element 610 of the GUI 600 of FIG. 6). The simulate option allows a user to simulate any setting for direct visual assessment (e.g., by displaying an image frames generated by the ISP with a fine-tuned setting from the list of settings displayed in the IQ metrics table 601 of FIG. 6). In some examples, the automated camera tool can provide image frames generated using multiple settings for comparison by a user (e.g., by displaying a first image frame generated using setting with setting number 0 and a second image frame generated using setting with setting number 1).

As noted above, user feedback regarding a specific aspect of IQ (e.g., texture, noise, edge sharpness, ringing artifacts, resolution, etc.) can be obtained and translated to a corresponding IQ metric target. A parameter settings search process can be performed to search among pre-generated trade-off settings to obtain the setting that lead to the desired metric target. The parameter settings search process can operate on a database (or other storage mechanism) of points based on the user's feedback provided through the GUI (e.g., GUI 600 of FIG. 6) of the automated camera tuning tool. For example, a dense database of points can be created when performing course tuning of an ISP or other component of a camera system (e.g., using a SmartU2 coarse tuning tool). Each data point in the database can correspond to particular course-tuned ISP parameter settings. In some cases, each data point can be stored (e.g., as a tuple or other data structure) with IQ metrics and ISP parameter settings. The points within the database can be searched to obtain the best point (e.g., corresponding to the best tuned ISP parameter settings) according to the user's feedback.

Each data point can be marked in the database by a set of IQ metrics and scores. The IQ metrics can include standardized metrics for global IQ assessment. In some examples, the IQ metrics can include visual noise metrics and modulation transfer function (MTF) based computations for features like texture, resolution, edge sharpness, and/or other features. In some examples, the IQ metrics can be computed using the TE42 chart, which is a multi-purpose chart for camera testing and tuning. The TE42 chart has various parts that can be used to measure the Opto-Electric Conversion Function (OECF), the dynamic range, the color reproduction quality, the white balance, the noise, the resolution, the shading, the distortion, and the kurtosis of a camera system. One or more other charts can also be used in addition to or as an alternative to the TE42 chart, such as the QA-62 chart, the TE106 chart, and/or other charts. In some cases, the scores can be obtained by combining multiple IQ metrics, as described above. In one illustrative example, a sharpness score can be determined by combining (e.g., using an additive formulation) MTFs for high frequency resolution, low frequency resolution, high contrast texture, and low contrast texture. In another illustrative example, a noise score cab be determined by combining luma and chroma aspects of visual noise. Other scores for the data points can also be determined.

In some examples, the IQ scores provided for points in the database can be for sharpness and noise, and/or for other characteristics. The scores are based on the IQ metrics and can be relied upon by user (e.g., OEM) engineers and tuners for providing an accurate correlation with the subjective image quality of image frames produced by the ISP. The scores can thus provide a useful shortlisting criteria.

FIG. 8 is a flow diagram illustrating an example of a parameter settings search process 800 for performing fine-tuning of ISP parameters. The process 800 can be used to translate or convert user feedback to a corresponding IQ metric target (referred to as a target metric value). The process 8000 can also be used to search a database of settings to obtain a setting that provides the desired metric target.

At operation 802, the process 800 includes receiving an indication of selection of a setting and an IQ metric to adjust. Determining the selection of the setting and the IQ metric to adjust can be based on operations 702, 704, and 706 of the process 700 of FIG. 7. For instance, a user can select a setting using the setting number graphical element 602 of the GUI 600 of FIG. 6. The user can select an IQ metric of the setting to adjust using the tuning option graphical element 604 of the GUI 600. In some examples, the user can select a strength or intensity of the adjustment (e.g., using the strength bar 606 of the GUI 600), as described above.

At operation 804, the process 800 includes removing points that have a redundant metric value for the selected IQ metric and/or points with worse IQ scores than the selected setting. For example, because the user can cause the camera tuning tool to perform fine-tuning with different settings as a starting point, it is possible that a same data point is reached via multiple paths. For example, a request to reduce noise on Setting_0 and a request to reduce texture on Setting_0 may result in the camera tuning tool outputting the same setting. Operation 804 can be performed to remove redundant points so that, if the output for a user's current fine-tuning step is already existing in the IQ metrics table (e.g., as a result of a previous fine-tuning step), another copy of that output would not be added to the table. In such an example, a setting for a data point is not displayed as a new setting in the IQ metrics table if the setting has metrics that are the same as another setting already displayed on the IQ metrics table. In some cases, operation 804 can be performed to remove points with worse IQ scores than the selected setting, as the low IQ scores can be indicative of a bad data point. Operation 804 is optional, and may not be performed in some implementations.

At operation 806, the process 800 includes determining whether the selection of the IQ metric indicates an increase or a decrease in the IQ metric. For example, as noted above, the tuning option graphical element 604 allows the user to indicate which IQ metric to adjust and how to adjust it (e.g., to increase the IQ metric or decrease the IQ metric). The process 800 can perform different operations based on whether the IQ metric is to be increased or decreased. For example, the process 800 can perform operation 808 if the IQ metric is to be decreased, and can perform operation 812 if the IQ metric is to be increased.

At operation 808 (when the IQ metric is to be decreased), the process 800 includes removing from the current search all points that have higher metric values for the selected IQ metric when compared to the metric value of the IQ metric for the selected setting. In one illustrative example, the selected IQ metric can include noise, and the noise value for the selected setting can be 82. In such an example, any points (corresponding to a parameter setting) having noise values higher than 82 can be removed from the current search. Operation 808 can be performed to prune the data points so that fewer data points are searched. The pruning performed by operation 808 can thus result in a more efficient search process. At operation 810, the process 800 includes setting or arranging the points in descending order, so that the values are listed from largest to smallest. For example, the points can be arranged in descending order with respect to the particular IQ metric for which a user requests enhancement. For instance, a user can request that the automated camera tuning tool increase resolution or increase texture, in which case the points can be sorted in descending order based on resolution or texture (the corresponding IQ metric).

At operation 812 (when the IQ metric is to be increased), the process 800 includes removing from the current search all points that have lower metric values for the selected IQ metric as compared to the metric value of the IQ metric for the selected setting. In one illustrative example, the selected IQ metric can include resolution, and the resolution value for the selected setting can be 85. Any points (corresponding to a parameter setting) having resolution values less than 85 can be removed from the current search. Similar to operation 808, operation 812 can be performed to prune the data points so that fewer data points are searched. At operation 814, the process 800 includes setting or arranging the points in ascending order, so that the values are listed from smallest to largest.

At operation 816, the process 800 includes determining a metric factor. As described below, the metric factor can be used at operation 818 to determine a target metric value. The metric factor can be determined based on the selected IQ metric and the data point with an extreme value (extrema) for the IQ metric among the data points that are left over after the pruning operations of operation 808 or the operation 812. The extreme value can be the data point with the lowest or highest value for the IQ metric from among the data points that are left over. In some cases, the total size of the database (e.g., the number of data points) can also be taken into account when determining the metric factor. In some examples, the total size of the database can include the size of the entire database (before operation 804 and either operation 808 or 812 are performed). In some examples, the total size of the database can include the size of the database after operation 804 and either operation 808 or 812 are performed. In one illustrative example, the metric factor can be determined or computed as follows (based on the total size of the database):

$$multfact = \frac{\vert metri {c}_{current} - m e t r i {c}_{e x t r e m a} \vert}{total size of database} \qquad Equation ( 1 )$$

where multfact is the metric factor, metric_{current} is the value of the selected metric, metricₑₓₜᵣₑₘₐ is the value of the extreme data point, and total size of database is the size of the database (either before or after operation 804 and either operation 808 or 812 are performed). Equation (1) provides the distance between every point in the database (or less than every point in the database in some cases), assuming there is a uniform distribution in the database (e.g., the distance between the current point and the extrema divided by the total number of points). The multfact term indicates the step size from the current metric to the extrema metric, assuming a uniform distribution of the data points in the database. As indicated below with respect to operation 818, the strength of the adjustment indicated by the user (e.g., selected using the strength bar 606) can be used to determine how many steps to take with respect to the step size indicated by the multfact.

At operation 818, the process 800 includes determining a target metric value. The target metric value can be determined based on the selected IQ metric, the strength or intensity indicated by the user (e.g., selected using the strength bar 606), a desired size of the output (e.g., how many outputs to provide), and the metric factor (e.g., multfact). In one illustrative example, the target metric value can be determined or computed as follows:

metric_{target}=metric_{current}+(strength)*(idx of output)*(multfact) Equation (2)

where metric_{target} is the target metric, metric_{current} is the value of the selected metric, strength is the strength or intensity of the adjustment to the IQ metric (e.g., selected by the user using the strength bar 606), and idx of output is the index of output (or output size) according to how many outputs to provide, and multfact is the metric factor determined using equation (1). As indicated by equation (2), the target metric (metric_{target}) is determined by modifying the selected IQ metric (metric_{current}) based on the step size defined by the metric factor (multfact). The number of steps are controlled by the strength of adjustment (strength) and the output size (idx of output). For example, if a user indicates a desire to reduce noise by a factor of −2 (where strength=−2), two times the step size defined by multfact will be subtracted from the current metric (metric_{current}), resulting in a larger reduction in noise as compared to a strength of −1 or 0.

If multiple outputs are desired, then each output will be generated using incremental values according to the number of multiple outputs. For instance, if a user indicates that two outputs are desired, two target metrics can be determined. For the first target metric, the index of output can be equal to 1, which corresponds to a first step defined by the strength value and the metric factor value. For the second target metric, the index of output can be equal to 2, which corresponds to a second step defined by the strength value and the metric factor value. In one illustrative example, if a user indicates a desire to reduce noise by a factor of 1 (strength=−1) and requests the camera tuning tool to generate two outputs, the first target metric (with idx of output=1) will be determined as the target metric minus the value of multfact (a single step size due to the strength being to 1). The second target metric (with idx of output=2) will be determined as the target metric minus two times the value of multfact (two step sizes). In another illustrative example, if a user indicates a desire to reduce noise by a factor of 2 (strength=−2) and requests two outputs, the first target metric (with idx of output=1) will be determined as the target metric minus two times the value of multfact (two step sizes due to the strength being to 2). The second target metric (with idx of output=2) will be determined as the target metric minus four times the value of multfact (four step sizes).

At operation 820, the process 800 includes outputting the data point having an IQ metric closest to the target metric value determined at operation 818. The IQ score associated with the data point can also be output in some cases. For example, the IQ score associated with an output data point can be displayed in the IQ metrics table 601 of FIG. 6 (e.g., as shown in Table 1 and Table 2 below). As noted above, each data point has associated tuned parameter settings (e.g., tuned ISP parameter settings). Accordingly, identifying a data point as having a closest IQ metric value to the target metric value essentially identifies the tuned parameter settings that achieve the enhancement or adjustment goal indicated by the user feedback. A data point can be output for each index of output corresponding to the output size. For instance, in the example above where the user requests two outputs, a first data point can be output for the index value of 1 (with idx of output=1) and a second data point can be output for the index value of 2 (with idx of output=2).

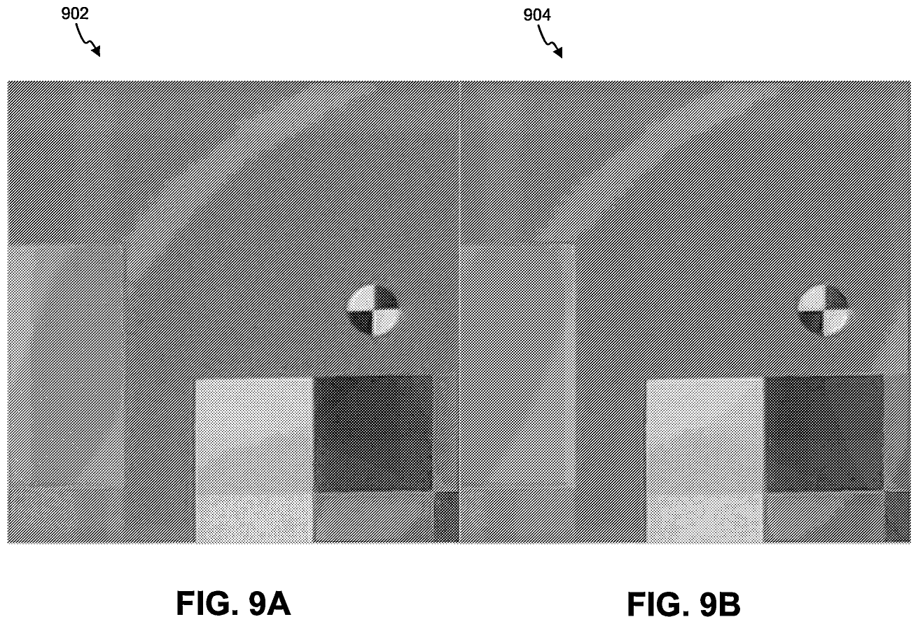

Examples of application of the automated camera tuning processes described above are provided with respect to Table 1 and Table 2 below and FIG. 9A-FIG. 11B. Table 1 illustrates results from subjective IQ improvement in a camera. In the example of Table 1, a requirement can be indicated (e.g., from an OEM) that noise is to be reduced with minor improvements in sharpness and details (or resolution). A user can select (e.g., using the GUI 600 of FIG. 6) the coarse tuning setting with the most desirable sharpness and resolution, and can instruct (e.g., using the GUI 600 of FIG. 6) the camera tuning tool can reduce noise by strength of −2 to get the first set of outputs, followed by further noise reduction by a strength of −1 on the output setting Out_1_c, as shown in Table 1. The camera tuning tool can perform the processes 700 and 800 to generate the outputs shown in Table 1. As illustrated by the arrow in Table 1 from the sharpness score of 68.46 to the sharpness score of 72.12, there is an increase in both sharpness and noise scores, indicating better IQ. For the final output (further reducing noise by strength of −1), only the two shortlisted images Out_2_a and Out_2_b are simulated, and the one with better subjective sharpness (Out_2_a) is chosen as the final output.

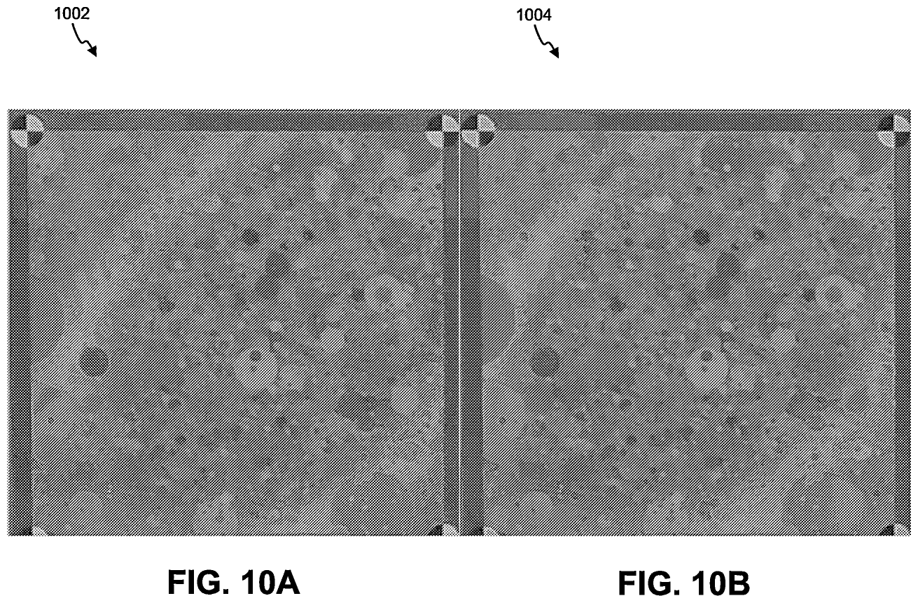

The enhancement obtained in terms of noise and sharpness from coarse tuned setting as compared to the final shortlisted fine-tuned setting Out_2_a is illustrated by the images shown in FIG. 9A, FIG. 9B, FIG. 10A, and FIG. 10B.

The image frames 902 and 904 in FIG. 9A and FIG. 9B provide, for a camera of a particular mobile device in a 20 lux condition, a comparison between a noise profile of a coarse-tuned setting (illustrated by the image frame 902 in FIG. 9A) and a noise profile of the selected fine-tuned setting Out_2_a from Table 1 (illustrated by the image frame 904 in FIG. 9B), as determined by the automated camera tuning tool. It can be observed that the fine-tuned setting resulting in the image frame 904 of FIG. 9B results in less noise than the coarse-tuned setting resulting in the image frame 902 of FIG. 9A.

The image frames 1002 and 1004 in FIG. 10A and FIG. 10B provide, for a camera of a particular mobile device in a 20 lux condition, a comparison between texture details of a coarse-tuned setting (illustrated by the image frame 1002 in FIG. 10A) and texture details of the selected fine-tuned setting Out_2_a from Table 1 (illustrated by the image frame 1002 in FIG. 10B), as determined by the automated camera tuning tool. It can be observed that the fine tuning performed to obtain the cleaner noise profile has not compromised the texture details. For example, the image frame 1004 of FIG. 10B has reduced noise but similar texture details as the image frame 1002 of FIG. 10A.

In some cases, camera or device manufacturers (e.g., OEMs) may desire higher resolution captures for better image quality, in which case fine tuning by manual iterative simulations (e.g., using the process 200 shown in FIG. 2) will be extremely time consuming. For instance, a single simulation of 5-frame Multi-Frame Noise Reduction (MFNR) for a device with a sensor-ISP combination of an IMX586 sensor and a Snapdragon 855 ISP takes approximately 15 minutes on a high-performing computing device. The automated camera tuning tool described herein can greatly reduce the time to obtain the desired fine-tuned enhancements. For a mid-light lux condition of the device, coarse tuned output had excessive noise cleaning, causing loss of details. Using the automated camera tuning tool, fine-tuning can be performed to bring back the necessary texture details. Such fine-tuning can be achieved by selecting a coarse tuned setting (e.g., from the IQ metrics table 601 of FIG. 6) and increasing texture by strength +2, as shown in Table 2. As illustrated by the arrow in Table 2 from the sharpness score of 72.9 to the sharpness score of 74.50, there is a significant increase in sharpness, with a slight loss in noise score.

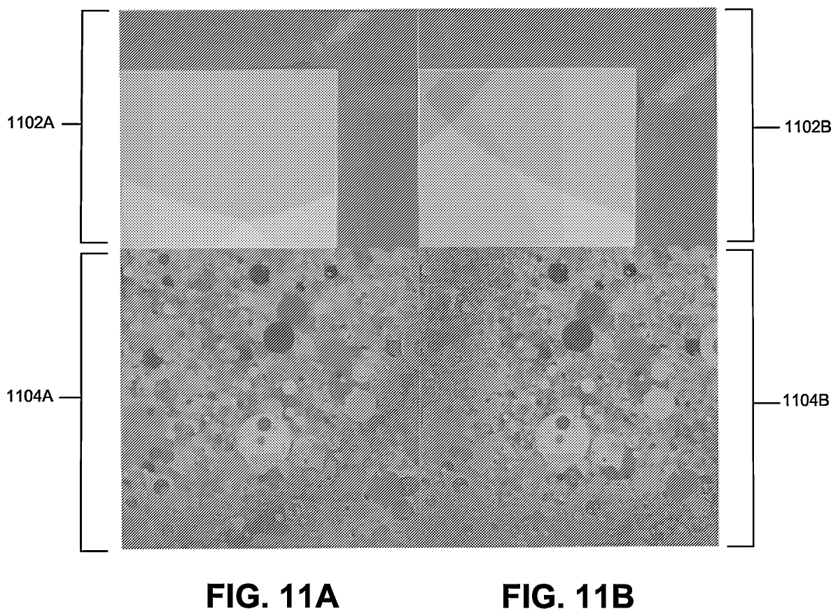

FIG. 11A and FIG. 11B provide an illustration of how texture details are enhanced using the Out_1_c setting obtained by the fine tuning tool as compared to the coarse-tuned setting, without compromising much on the noise profile. In particular, the images in FIG. 11A and FIG. 11B provide, for a camera of a particular mobile device, a comparison between images generated using a coarse tuned setting (FIG. 11A) and a fine-tuned setting Out_1_c (FIG. 11B), as determined by the automated camera tuning tool. It can be observed that the fine-tuned setting results in an image with a higher level of texture detail (as shown by region 1104B of FIG. 11B versus region 1104A of FIG. 11A), without much difference in noise profile (as shown by region 1102B of FIG. 11B versus region 1102A of FIG. 11A).

In some cases, as noted above, a user of the automated camera tuning tool can be an end-user of the camera or device (e.g., mobile device) that includes the camera. For example, even in view of well-tuned ISP settings being offered by OEMs in various products, end-users might have their own preferences when it comes to the desired (subjective) image quality (IQ) of an output image frame. Existing end-user devices allow manual control for settings like exposure, shutter speed, automatic white balance (AWB), among others. However, the manual control options (e.g., through GUI graphical elements) span only some parts of IQ, and some users might not be aware of how the IQ metrics that are controllable would impact the image frame. Users generally have better understanding of the subjective image quality, like sharpness, saturation, tones, etc.

Existing end-user devices can also perform post-processing functions using built-in filters and/or applications to obtain various effects on the captured frame. However, such post-processing functions require an additional repeated effort, especially if users have a fixed kind of preference for the majority of the captured image frames.

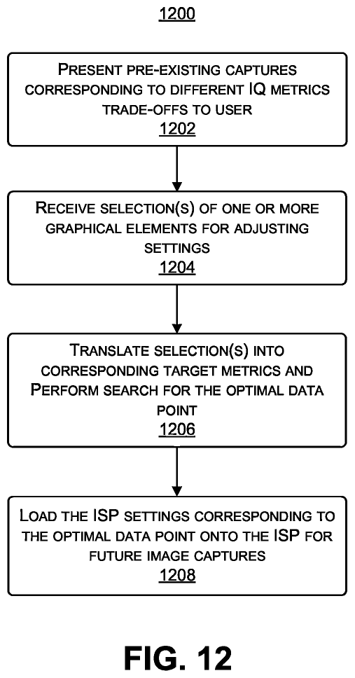

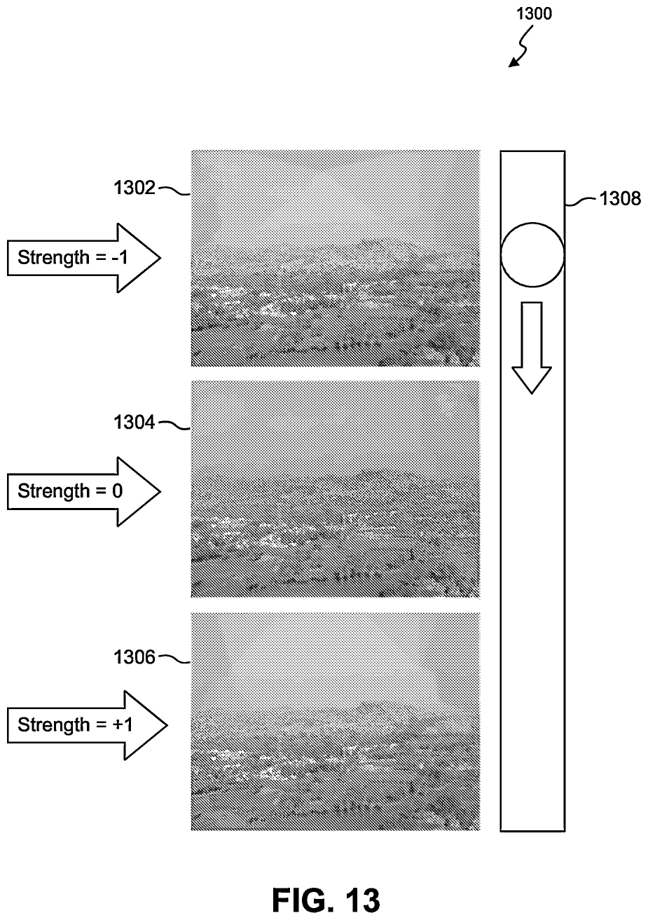

In some implementations, the process 700 and the search process 800 can adapted for end-users in order to provide custom camera settings that are personalized to suit the particular end-user. For example, ISP parameters can be pre-set based on feedback from the end-user indicating a desired saturation level, color tone, sharpening, and/or other IQ metrics. In some examples, the processes 700 and 800 can be performed during an initial camera settings set-up process (e.g., when the user boots up a new mobile device), prompting the user to provide feedback regarding various IQ metrics. In some cases, operation 802 of the search process 800 of FIG. 8 is modified for the end-user based system. For instance, as described below with respect to FIG. 12 and FIG. 13, a user may not select a particular setting and IQ metric, and may select an image frame that displays the characteristics desired by the user.

FIG. 12 is a flow diagram illustrating an example of a process 1200 for performing automated camera tuning based on feedback from an end-user. The process 1200 will be described with reference to an example graphical user interface (GUI) 1300 shown in FIG. 13. At operation 1202, the process 1200 includes presenting pre-existing captures (image frames) corresponding to different IQ metrics trade-offs to user. For instance, referring to the GUI 1300 of FIG. 13, a first image frame 1302, a second image frame 1304, and a third image frame 1306 are displayed in the GUI 1300. The image frames 1302, 1304, and 1306 are captures of natural scenes on which IQ metrics can be computed. In some examples, the displayed captures can be of standard charts used for tuning cameras (e.g., a TE42 chart, a QA-62 chart, a TE106 chart, and/or other charts). The image frames 1302, 1304, and 1306 can correspond to different saturation strengths for the same scene. For instance, the first image frame 1302 can correspond to a saturation strength of −1 (a decrease in saturation), the second image frame 1304 can correspond to a saturation strength of 0 (no change in saturation), and the third image frame 1306 can correspond to a saturation strength of +1 (an increase in saturation).

At operation 1204, the process 1200 includes receiving one or more selections of one or more graphical elements for adjusting settings. For instance, as shown in FIG. 13, the GUI 1300 can include a slider bar 1308. The slider bar 1308 is a selectable graphical element that allows the user to select the image frame corresponding to the user's desired saturation level. While a slider bar 1308 bar is shown in FIG. 13 as an example of a selectable graphical element, other selectable graphical elements can be used, such as drop-down menus, text entry boxes, selectable image frames (e.g., the first image frame 1302, the second image frame 1304, and the third image frame 1306 can be selected by the user), any combination thereof, and/or other selectable graphical element(s). Other selectable graphical elements can be displayed in association with other IQ metrics, such as selectable graphical elements (e.g., a slider bar) for selecting among captures for different color tones, sharpness, saturation, among other IQ metrics. For instance, graphical elements can be provided for increasing and/or decreasing saturation, sharpness, tone, among other IQ metrics, to allow the user to select from different captures depicting the different levels of IQ metrics.

At operation 1206, the process 1200 includes translating the one or more selections into corresponding target metrics and performing a search for the optimal output. The process 800 described above with respect to FIG. 8 can be used to perform the translation of the selections in to the target metric(s) and the search of the database of data points (corresponding to different ISP settings). For example, using the process 800 of FIG. 8, the user selections can be converted into corresponding target metrics (e.g., metric_{current}) and a search can be performed to determine the optimal output data point. As noted above, the search can be performed among data points corresponding to previously-generated (e.g., generated offline) ISP settings. For example, the data points can include course-tuned ISP settings or previously fine-tuned ISP settings.

At operation 1208, the process 1200 includes loading the ISP settings corresponding to the optimal data point onto the ISP for future image captures. For instance, the ISP of the device can be tuned with the ISP settings associated with the data point output at operation 820 of FIG. 8. The parameters corresponding to the newly searched setting that are loaded onto the ISP can be used for future captures. As described above, each data point is already stored (e.g., as a tuple or other data structure) with IQ metrics and ISP parameter settings, and thus can easily be obtained and loaded onto the ISP. The search is performed in the metrics space, but when the data point is chosen based on metrics, corresponding parameters settings are readily available can be quickly loaded onto the ISP. In some cases, a user can return to the GUI to retune the ISP settings if the user wants a different kind of capture with different characteristics.

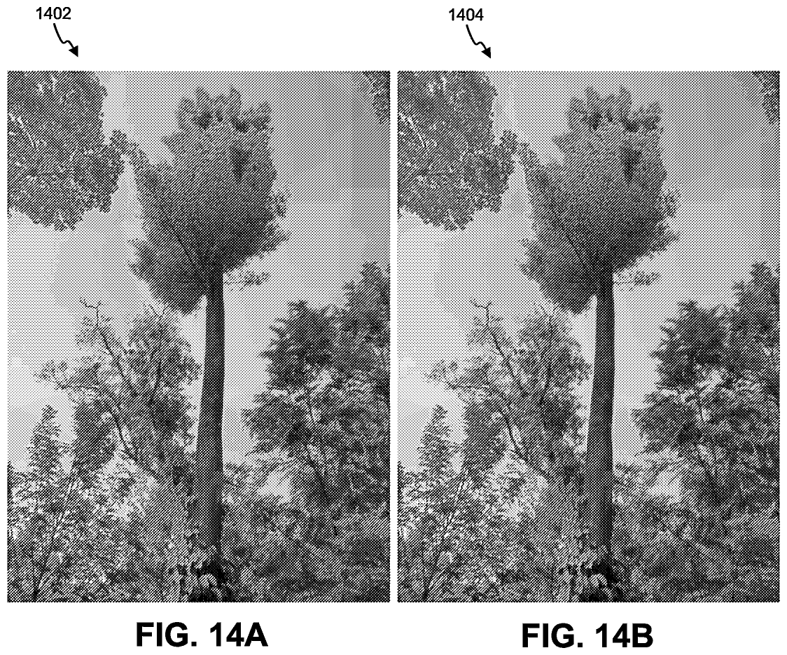

FIG. 14A and FIG. 14B are image frames 1402 and 1404 illustrating a comparison between capture results obtained using originally-tuned settings of a device and capture results obtained using fine-tuned settings that are determined according to the process 1200 of FIG. 12. For instance, a user can select a preference for color saturation (e.g., using the GUI 1300 of FIG. 13). The image frame 1402 of FIG. 14A corresponds to the originally tuned ISP, and the image frame 1404 of FIG. 14B corresponds to the ISP parameter settings chosen based on user feedback to increase color saturation.

The automated camera tuning systems and techniques described herein provide various benefits over existing camera tuning techniques (such as the process 200 of FIG. 2). For example, tuning using the automated camera tuning tool for different lux conditions (e.g., eight lux conditions) can take as little as one day using the automated camera tuning systems and techniques described herein, as compared to 7-10 days required for the manual tuning process 200 illustrated in FIG. 2. Further, each IQ change can be reverted to without keeping track of underlying parameter changes, ensuring easy repeatability. Another benefit is that only knowledge of subjective IQ is needed, irrespective of ISP evolution. For example, a user does not need to develop expertise over the thousands of ISP parameters.

The automated camera tuning systems and techniques described herein can translate subjective feedback from users to target metrics internally, and data points representing the trade-off metrics space is searched accordingly. The ISP parameters corresponding to a data point selected by metric target-based search can be output. Such a solution prevents a user from needing to manually tweak thousands of parameters for desired change in IQ. In some cases, from the end-user perspective, techniques described herein provide the end-user with control to personalize camera settings in order to automatically obtain the desired processing on image frame captures by pre-selected ISP settings. Desired image characteristics can thus be obtained without requiring the use of image post-processing.

The target metrics derived using the techniques described herein correlate well with desired subjective IQ. The automated camera tuning tool leads to tuned settings which have enhanced subjective image quality as per user requirement(s), with minimal simulation overhead and manual effort. The tool can reduce the fine-tuning time from one week to 2 days for 8 light conditions. The tool can also be integrated into existing camera tuning tools (e.g., the Chromatix tuning tool).

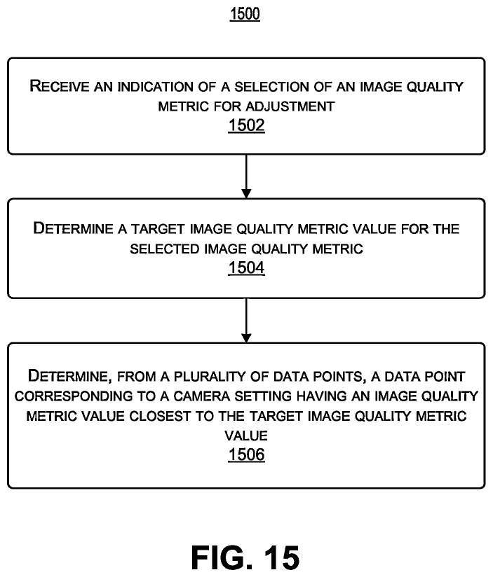

FIG. 15 is a flowchart illustrating an example of a process 1500 of determining one or more camera settings using the techniques described herein. At block 1502, the process 1500 includes receiving an indication of a selection of an image quality metric for adjustment. In some examples, the indication of the selection of the image quality metric includes a direction of adjustment. In some examples, the direction of adjustment includes a decrease in the image quality metric. In some examples, the direction of adjustment includes an increase in the image quality metric. In some implementations, the selection of the image quality metric for adjustment is based on selection of a graphical element of a graphical user interface, such as that shown in FIG. 6. In some aspects, the graphical element includes an option to increase or decrease the image quality metric. In some implementations, the graphical element is associated with a displayed image frame having an adjusted value for the image quality metric, such as that shown in FIG. 13. In some implementations, the selection of the image quality metric for adjustment is based on selection of a displayed image frame having an adjusted value for the image quality metric. For example, referring to FIG. 13, instead of operating the slider bar 1308, a user may select one of the image frames 1302, 1304, or 1306 to select the image quality metric for adjustment.

At block 1504, the process 1500 includes determining a target image quality metric value for the selected image quality metric. In some examples, the process 1500 includes determining a metric factor. In one example, operation 816 of process 800 can be performed to determine the metric factor. For instance, the process 1500 can determine the metric factor based on a metric value of the selected image quality metric, based on a data point from the plurality of data points having an extreme value for the selected image quality metric, and/or based on a number of the plurality of data points (e.g., as described above with respect operation 816 to FIG. 8). The process 1500 can include determining the target image quality metric value for the selected image quality metric based on the metric value of the selected image quality metric and the metric factor (e.g., as described above with respect operation 818 to FIG. 8).

In some examples, the process 1500 includes receiving an indication of a selection of a strength of the adjustment to image quality metric. For instance, a user can select the strength of the adjustment using the strength bar 606 of the GUI 600 of FIG. 6. The process 1500 can include determining the target image quality metric value for the selected image quality metric based on the metric value of the selected image quality metric, the metric factor, and the strength of the adjustment to the image quality metric (e.g., as described above with respect operation 818 to FIG. 8).

In some examples, the process 1500 includes receiving an indication of a selection of a number of desired output camera settings. For instance, a user can select the number of desired output camera settings using the setting number graphical element 602 of the GUI 600 of FIG. 6. The process 1500 can include determining the target image quality metric value for the selected image quality metric based on the metric value of the selected image quality metric, the metric factor, and the number of desired output camera settings (e.g., as described above with respect operation 818 to FIG. 8).

In some examples, the process 1500 includes receiving the indication of the selection of a strength of the adjustment to image quality metric and receiving the indication of the selection of a number of desired output camera settings. The process 1500 can include determining the target image quality metric value for the selected image quality metric based on the metric value of the selected image quality metric, the metric factor, the strength of the adjustment to the image quality metric, and the number of desired output camera settings (e.g., as described above with respect operation 818 to FIG. 8).

At block 1506, the process 1500 includes determining, from a plurality of data points, a data point corresponding to a camera setting having an image quality metric value closest to the target image quality metric value. In some examples, the process 1500 includes removing, from the plurality of data points, one or more data points having a same metric value for the selected image quality metric (e.g., as described above with respect to operation 804 to FIG. 8).

In some examples, the process 1500 includes receiving an indication of a selection of a particular camera setting for adjustment (e.g., from the IQ metrics table 601 in the GUI 600 of FIG. 6). In such examples, the selected image quality metric is associated with the particular camera setting. In some cases, the process 1500 includes removing, from the plurality of data points, one or more data points corresponding to one or more camera settings having lower scores than the particular camera setting (e.g., as described above with respect to operation 804 to FIG. 8). In some examples, the process 1500 includes removing, from the plurality of data points, one or more data points corresponding to one or more camera settings having a same metric value for the selected image quality metric and having lower scores than the particular camera setting (e.g., as described above with respect to operation 804 to FIG. 8).

In some examples, the process 1500 includes determining, based on the indication of the selection of the image quality metric, a direction of adjustment for the image quality metric includes a decrease in the image quality metric. The process 1500 can include removing, from the plurality of data points, one or more data points corresponding to one or more camera settings having a higher metric value for the selected image quality metric than the particular camera setting (e.g., as described above with respect operation 808 to FIG. 8). In some examples, removing the one or more data points from the plurality of data points results in a group of data points. In some aspects, the process 1500 includes sorting the group of data points in descending order (e.g., as described above with respect operation 810 to FIG. 8).

In some examples, the process 1500 includes determining, based on the indication of the selection of the image quality metric, a direction of adjustment for the image quality metric includes an increase in the image quality metric. The process 1500 can include removing, from the plurality of data points, one or more data points corresponding to one or more camera settings having a lower metric value for the selected image quality metric than the particular camera setting (e.g., as described above with respect operation 812 to FIG. 8). As noted above, removing the one or more data points from the plurality of data points results in a group of data points. In some examples, the process 1500 includes sorting the group of data points in ascending order (e.g., as described above with respect operation 814 to FIG. 8).

In some examples, the process 1500 includes outputting information associated with the determined data point for display. In some examples, the process 1500 includes tuning an image signal processor (ISP) using the camera setting corresponding to the determined data point.

In some examples, the processes described herein (e.g., process 700, process 800, process 1200, process 1500, and/or other process described herein) may be performed by a computing device or apparatus. In one example, the process 700, the process 800, the process 1200, and/or the process 1500 can be performed by the device 101 or the computing device 1600 of FIG. 16. In some cases, the device 101 can include components of the computing device 1600 of FIG. 16 in addition to the components shown in FIG. 1. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle, a robotic device, and/or any other computing device with the resource capabilities to perform the processes described herein, including the process 700, the process 800, the process 1200, and/or the process 1500. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 700, 800, 1200, and 1500 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 16 illustrates an example computing device architecture 1600 of an example computing device which can implement the various techniques described herein. For example, the computing device architecture 1600 can be part of the device 101 (including camera 105), and can be used to implement any of the processes described herein (including process 700, process 800, process 1200, and/or process 1500). The components of computing device architecture 1600 are shown in electrical communication with each other using connection 1605, such as a bus. The example computing device architecture 1600 includes a processing unit (CPU or processor) 1610 and computing device connection 1605 that couples various computing device components including computing device memory 1615, such as read only memory (ROM) 1620 and random access memory (RAM) 1625, to processor 1610.

Computing device architecture 1600 can include a cache of high-speed memory connected directly with, in close proximity to, or integrated as part of processor 1610. Computing device architecture 1600 can copy data from memory 1615 and/or the storage device 1630 to cache 1612 for quick access by processor 1610. In this way, the cache can provide a performance boost that avoids processor 1610 delays while waiting for data. These and other modules can control or be configured to control processor 1610 to perform various actions. Other computing device memory 1615 may be available for use as well. Memory 1615 can include multiple different types of memory with different performance characteristics. Processor 1610 can include any general purpose processor and a hardware or software service, such as service 1 1632, service 2 1634, and service 3 1636 stored in storage device 1630, configured to control processor 1610 as well as a special-purpose processor where software instructions are incorporated into the processor design. Processor 1610 may be a self-contained system, containing multiple cores or processors, a bus, memory controller, cache, etc. A multi-core processor may be symmetric or asymmetric.

To enable user interaction with the computing device architecture 1600, input device 1645 can represent any number of input mechanisms, such as a microphone for speech, a touch-sensitive screen for gesture or graphical input, keyboard, mouse, motion input, speech and so forth. Output device 1635 can also be one or more of a number of output mechanisms known to those of skill in the art, such as a display, projector, television, speaker device, etc. In some instances, multimodal computing devices can enable a user to provide multiple types of input to communicate with computing device architecture 1600. Communication interface 1640 can generally govern and manage the user input and computing device output. There is no restriction on operating on any particular hardware arrangement and therefore the basic features here may easily be substituted for improved hardware or firmware arrangements as they are developed.

Storage device 1630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1625, read only memory (ROM) 1620, and hybrids thereof. Storage device 1630 can include services 1632, 1634, 1636 for controlling processor 1610. Other hardware or software modules are contemplated. Storage device 1630 can be connected to the computing device connection 1605. In one aspect, a hardware module that performs a particular function can include the software component stored in a computer-readable medium in connection with the necessary hardware components, such as processor 1610, connection 1605, output device 1635, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative examples of the disclosure include:

Aspect 1: A method of determining one or more camera settings, the method comprising: receiving an indication of a selection of an image quality metric for adjustment; determining a target image quality metric value for the selected image quality metric; and determining, from a plurality of data points, a data point corresponding to a camera setting having an image quality metric value closest to the target image quality metric value.

Aspect 2: The method of Aspect 1, wherein the indication of the selection of the image quality metric includes a direction of adjustment.

Aspect 3: The method of Aspect 2, wherein the direction of adjustment includes a decrease in the image quality metric or an increase in the image quality metric.

Aspect 4: The method of any of Aspects 1 to 3, further comprising: removing, from the plurality of data points, one or more data points having a same metric value for the selected image quality metric.

Aspect 5: The method of any of Aspects 1 to 4, further comprising: receiving an indication of a selection of a particular camera setting for adjustment, wherein the selected image quality metric is associated with the selected particular camera setting.

Aspect 6: The method of Aspect 5, further comprising: removing, from the plurality of data points, one or more data points corresponding to one or more camera settings having lower scores than the selected particular camera setting.

Aspect 7: The method of Aspect 5, further comprising: removing, from the plurality of data points, one or more data points corresponding to one or more camera settings having a same metric value for the selected image quality metric and having lower scores than the selected particular camera setting.

Aspect 8: The method of any of Aspects 1 to 7, further comprising: determining, based on the indication of the selection of the image quality metric, a direction of adjustment for the image quality metric includes a decrease in the image quality metric; and removing, from the plurality of data points, one or more data points corresponding to one or more camera settings having a higher metric value for the selected image quality metric than the selected particular camera setting.

Aspect 9: The method of Aspect 8, wherein removing the one or more data points from the plurality of data points results in a group of data points, the method further comprising: sorting the group of data points in descending order.

Aspect 10: The method of any of Aspects 1 to 9, further comprising: determining, based on the indication of the selection of the image quality metric, a direction of adjustment for the image quality metric includes an increase in the image quality metric; and removing, from the plurality of data points, one or more data points corresponding to one or more camera settings having a lower metric value for the selected image quality metric than the selected particular camera setting.

Aspect 11: The method of Aspect 10, wherein removing the one or more data points from the plurality of data points results in a group of data points, the method further comprising: sorting the group of data points in ascending order.

Aspect 12: The method of any of Aspects 1 to 11, further comprising: determining a metric factor based on a metric value of the selected image quality metric, a data point from the plurality of data points having an extreme value for the selected image quality metric, and a number of the plurality of data points; and determining the target image quality metric value for the selected image quality metric based on the metric value of the selected image quality metric and the metric factor.

Aspect 13: The method of Aspect 12, further comprising: receiving an indication of a selection of a strength of the adjustment to image quality metric; and determining the target image quality metric value for the selected image quality metric based on the metric value of the selected image quality metric, the metric factor, and the strength of the adjustment to the image quality metric.

Aspect 14: The method of Aspect 12, further comprising: receiving an indication of a selection of a number of desired output camera settings; and determining the target image quality metric value for the selected image quality metric based on the metric value of the selected image quality metric, the metric factor, and the number of desired output camera settings.

Aspect 15: The method of Aspect 12, further comprising: receiving an indication of a selection of a strength of the adjustment to image quality metric; receiving an indication of a selection of a number of desired output camera settings; and determining the target image quality metric value for the selected image quality metric based on the metric value of the selected image quality metric, the metric factor, the strength of the adjustment to the image quality metric, and the number of desired output camera settings.

Aspect 16: The method of any of Aspects 1 to 15, further comprising: outputting information associated with the determined data point for display.

Aspect 17: The method of any of Aspects 1 to 16, further comprising: tuning an image signal process using the camera setting corresponding to the determined data point.

Aspect 18: The method of any of Aspects 1 to 17, wherein the selection of the image quality metric for adjustment is based on selection of a graphical element of a graphical user interface.

Aspect 19: The method of Aspect 18, wherein the graphical element includes an option to increase or decrease the image quality metric.

Aspect 20: The method of Aspect 18, wherein the graphical element is associated with a displayed image having an adjusted value for the image quality metric.

Aspect 21: The method of any of Aspects 1 to 20, wherein the selection of the image quality metric for adjustment is based on selection of a displayed image frame having an adjusted value for the image quality metric.

Aspect 22: The method of any of Aspects 1 to 21, wherein the camera setting is associated with one or more image signal processor settings.

Aspect 23: An apparatus for determining one or more camera settings. The apparatus includes a memory (e.g., implemented in circuitry) and a processor (or multiple processors) coupled to the memory. The processor (or processors) is configured to: receive an indication of a selection of an image quality metric for adjustment; determine a target image quality metric value for the selected image quality metric; determine, from a plurality of data points, a data point corresponding to a camera setting having an image quality metric value closest to the target image quality metric value.

Aspect 24: The apparatus of Aspect 23, wherein the indication of the selection of the image quality metric includes a direction of adjustment.

Aspect 25: The apparatus of Aspect 24, wherein the direction of adjustment includes a decrease in the image quality metric or an increase in the image quality metric.

Aspect 26: The apparatus of any of Aspects 23 to 25, wherein the processor is configured to: remove, from the plurality of data points, one or more data points having a same metric value for the selected image quality metric.

Aspect 27: The apparatus of any of Aspects 23 to 26, wherein the processor is configured to: receive an indication of a selection of a particular camera setting for adjustment, wherein the selected image quality metric is associated with the selected particular camera setting.

Aspect 28: The apparatus of Aspect 27, wherein the processor is configured to: remove, from the plurality of data points, one or more data points corresponding to one or more camera settings having lower scores than the selected particular camera setting.

Aspect 29: The apparatus of Aspect 27, wherein the processor is configured to: remove, from the plurality of data points, one or more data points corresponding to one or more camera settings having a same metric value for the selected image quality metric and have lower scores than the selected particular camera setting.

Aspect 30: The apparatus of any of Aspects 23 to 29, wherein the processor is configured to: determining, based on the indication of the selection of the image quality metric, a direction of adjustment for the image quality metric includes a decrease in the image quality metric; remove, from the plurality of data points, one or more data points corresponding to one or more camera settings having a higher metric value for the selected image quality metric than the selected particular camera setting.

Aspect 31: The apparatus of Aspect 30, wherein the processor is configured to: sort the group of data points in descend order.

Aspect 32: The apparatus of any of Aspects 23 to 31, wherein the processor is configured to: determine, based on the indication of the selection of the image quality metric, a direction of adjustment for the image quality metric includes an increase in the image quality metric; remove, from the plurality of data points, one or more data points corresponding to one or more camera settings having a lower metric value for the selected image quality metric than the selected particular camera setting.

Aspect 33: The apparatus of Aspect 32, wherein the processor is configured to: sort the group of data points in ascend order.

Aspect 34: The apparatus of any of Aspects 23 to 33, wherein the processor is configured to: determine a metric factor based on a metric value of the selected image quality metric, a data point from the plurality of data points having an extreme value for the selected image quality metric, and a number of the plurality of data points; determine the target image quality metric value for the selected image quality metric based on the metric value of the selected image quality metric and the metric factor.

Aspect 35: The apparatus of Aspect 34, wherein the processor is configured to: receive an indication of a selection of a strength of the adjustment to image quality metric; determine the target image quality metric value for the selected image quality metric based on the metric value of the selected image quality metric, the metric factor, and the strength of the adjustment to the image quality metric.

Aspect 36: The apparatus of Aspect 34, wherein the processor is configured to: receive an indication of a selection of a number of desired output camera settings; determine the target image quality metric value for the selected image quality metric based on the metric value of the selected image quality metric, the metric factor, and the number of desired output camera settings.

Aspect 37: The apparatus of Aspect 34, wherein the processor is configured to: receive an indication of a selection of a strength of the adjustment to image quality metric; receive an indication of a selection of a number of desired output camera settings; determine the target image quality metric value for the selected image quality metric based on the metric value of the selected image quality metric, the metric factor, the strength of the adjustment to the image quality metric, and the number of desired output camera settings.

Aspect 38: The apparatus of any of Aspects 23 to 37, wherein the processor is configured to: output information associated with the determined data point for display.

Aspect 39: The apparatus of any of Aspects 23 to 38, wherein the processor is configured to: tune an image signal process use the camera setting correspond to the determined data point.

Aspect 40: The apparatus of any of Aspects 23 to 39, wherein the selection of the image quality metric for adjustment is based on selection of a graphical element of a graphical user interface.

Aspect 41: The apparatus of Aspect 40, wherein the graphical element includes an option to increase or decrease the image quality metric.

Aspect 42: The apparatus of Aspect 40, wherein the graphical element is associated with a displayed image having an adjusted value for the image quality metric.

Aspect 43: The apparatus of any of Aspects 23 to 42, wherein the selection of the image quality metric for adjustment is based on selection of a displayed image frame having an adjusted value for the image quality metric.

Aspect 44: The apparatus of any of Aspects 23 to 43, wherein the camera setting is associated with one or more image signal processor settings.

Aspect 45: The apparatus of any of Aspects 23 to 44, further comprising a display configured to display one or more image frames.

Aspect 46: The apparatus of any of Aspects 23 to 45, further comprising a camera configured to capture one or more image frames.

Aspect 47. The apparatus of any one of Aspects 23 to 46, wherein the apparatus is a mobile device.

Aspect 48. A computer-readable storage medium storing instructions that, when executed, cause one or more processors to perform any of the operations of Aspects 1 to 22.

Aspect 49. An apparatus comprising means for performing any of the operations of Aspects 1 to 22.

1. A method of determining one or more camera settings, the method comprising:
receiving an indication of a selection of an image quality metric for adjustment;
determining a target image quality metric value for the selected image quality metric; and
determining, from a plurality of data points, a data point corresponding to a camera setting having an image quality metric value closest to the target image quality metric value.

2. The method of claim 1, wherein the indication of the selection of the image quality metric includes a direction of adjustment.

3. The method of claim 2, wherein the direction of adjustment includes a decrease in the image quality metric or an increase in the image quality metric.

4. The method of claim 1, further comprising:
removing, from the plurality of data points, one or more data points having a same metric value for the selected image quality metric.

5. The method of claim 1, further comprising:
receiving an indication of a selection of a particular camera setting for adjustment, wherein the selected image quality metric is associated with the selected particular camera setting.

6. The method of claim 5, further comprising:
removing, from the plurality of data points, one or more data points corresponding to one or more camera settings having lower scores than the selected particular camera setting.

7. The method of claim 5, further comprising:
removing, from the plurality of data points, one or more data points corresponding to one or more camera settings having a same metric value for the selected image quality metric and having lower scores than the selected particular camera setting.

8. The method of claim 5, further comprising:
determining, based on the indication of the selection of the image quality metric, a direction of adjustment for the image quality metric includes a decrease in the image quality metric; and
removing, from the plurality of data points, one or more data points corresponding to one or more camera settings having a higher metric value for the selected image quality metric than the selected particular camera setting.

9. The method of claim 8, wherein removing the one or more data points from the plurality of data points results in a group of data points, the method further comprising:
sorting the group of data points in descending order.

10. The method of claim 5, further comprising:
determining, based on the indication of the selection of the image quality metric, a direction of adjustment for the image quality metric includes an increase in the image quality metric; and
removing, from the plurality of data points, one or more data points corresponding to one or more camera settings having a lower metric value for the selected image quality metric than the selected particular camera setting.

11. The method of claim 10, wherein removing the one or more data points from the plurality of data points results in a group of data points, the method further comprising:
sorting the group of data points in ascending order.

12. The method of claim 1, further comprising:
determining a metric factor based on a metric value of the selected image quality metric, a data point from the plurality of data points having an extreme value for the selected image quality metric, and a number of the plurality of data points; and
determining the target image quality metric value for the selected image quality metric based on the metric value of the selected image quality metric and the metric factor.

13. The method of claim 12, further comprising:
receiving an indication of a selection of a strength of the adjustment to image quality metric; and
determining the target image quality metric value for the selected image quality metric based on the metric value of the selected image quality metric, the metric factor, and the strength of the adjustment to the image quality metric.

14. The method of claim 12, further comprising:
receiving an indication of a selection of a number of desired output camera settings; and
determining the target image quality metric value for the selected image quality metric based on the metric value of the selected image quality metric, the metric factor, and the number of desired output camera settings.

15. The method of claim 12, further comprising:
receiving an indication of a selection of a strength of the adjustment to image quality metric;
receiving an indication of a selection of a number of desired output camera settings; and
determining the target image quality metric value for the selected image quality metric based on the metric value of the selected image quality metric, the metric factor, the strength of the adjustment to the image quality metric, and the number of desired output camera settings.

16. The method of claim 1, further comprising:
outputting information associated with the determined data point for display.

17. The method of claim 1, further comprising:
tuning an image signal process using the camera setting corresponding to the determined data point.

18. The method of claim 1, wherein the selection of the image quality metric for adjustment is based on selection of a graphical element of a graphical user interface.

19. The method of claim 18, wherein the graphical element includes an option to increase or decrease the image quality metric.

20. The method of claim 18, wherein the graphical element is associated with a displayed image having an adjusted value for the image quality metric.

21. The method of claim 1, wherein the selection of the image quality metric for adjustment is based on selection of a displayed image frame having an adjusted value for the image quality metric.

22. The method of claim 1, wherein the camera setting is associated with one or more image signal processor settings.

23. An apparatus for determining one or more camera settings, comprising:
a memory configured to store one or more camera settings; and
a processor coupled to the memory and configured to:
receive an indication of a selection of an image quality metric for adjustment;
determine a target image quality metric value for the selected image quality metric; and
determine, from a plurality of data points, a data point corresponding to a camera setting having an image quality metric value closest to the target image quality metric value.

24. The apparatus of claim 23, wherein the indication of the selection of the image quality metric includes a direction of adjustment, the direction of adjustment including a decrease in the image quality metric or an increase in the image quality metric.

25. The apparatus of claim 23, where the processor is configured to:
receive an indication of a selection of a particular camera setting for adjustment, wherein the selected image quality metric is associated with the selected particular camera setting.

26. The apparatus of claim 25, where the processor is configured to:
remove, from the plurality of data points, one or more data points corresponding to one or more camera settings having lower scores than the selected particular camera setting.

27. The apparatus of claim 25, where the processor is configured to:
remove, from the plurality of data points, one or more data points corresponding to one or more camera settings having a same metric value for the selected image quality metric and having lower scores than the selected particular camera setting.

28. The apparatus of claim 25, where the processor is configured to:
determine, based on the indication of the selection of the image quality metric, a direction of adjustment for the image quality metric includes a decrease in the image quality metric; and
remove, from the plurality of data points, one or more data points corresponding to one or more camera settings having a higher metric value for the selected image quality metric than the selected particular camera setting.

29. The apparatus of claim 23, further comprising at least one of a display configured to display one or more image frames and a camera configured to capture one or more image frames.

30. A non-transitory computer-readable medium is provided that has stored thereon instructions that, when executed by one or more processors, cause the one or more processor to:
receive an indication of a selection of an image quality metric for adjustment;
determine a target image quality metric value for the selected image quality metric; and
determine, from a plurality of data points, a data point corresponding to a camera setting having an image quality metric value closest to the target image quality metric value.
